(19) United States
(12) Patent Application Publication
(10) Pub. No.: US 2022/0256872 A1
(43) Pub. Date: Aug. 18, 2022

(54) PROCESS FOR PRODUCING A FERMENTED MILK PRODUCT WITH AN ENHANCED LEVEL OF PROBIOTICS

(71) Applicant: Chr. Hansen A/S, Hoersholm (DK)

(72) Inventors: Mirjana CURIC-BAWDEN, Milwaukee, WI (US); Matt NICHOLSON, Milwaukee, WI (US)

(73) Assignee: Chr. Hansen A/S, Hoersholm (DK)

(21) Appl. No.: 17/613,905

(22) PCT Filed: May 26, 2020
(86) PCT No.: PCT/EP2020/064567

§ 371 Date: Nov. 23, 2021

(30) Foreign Application Priority Data
May 28, 2019 (EP) 19177015.5

(51) Int. Cl. A23C 9/123

(52) U.S. Cl. CPC A23C 9/1238; A23C 9/1234; A23Y 2240/75; C12R 2001/23; A23Y 2220/73; A23Y 2300/49; A23Y 2220/03; A23Y 2220/15

(57) ABSTRACT

The present invention relates to compositions and methods for producing fermented milk products with increased amount of probiotic bacteria. In particular, the invention relates to a process for producing a fermented milk which comprises adding to a milk base (i) a starter culture comprising at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, (ii) one or more non-lactose carbohydrate capable of being metabolized by the lactic acid bacteria, in an amount measured so as to become depleted when the pH of the fermented milk product is between 4.9 and 5.5 and (iii) a probiotic strain selected from a Lactobacillus strain and a Bifidobacterium strain. In addition, the present invention relates to compositions and to fermented milk food or feed products produced by the process of the invention.

### FIELD OF THE INVENTION

The present invention relates to compositions and methods for producing fermented milk products with increased amount of probiotic bacteria.

### BACKGROUND OF THE INVENTION

Probiotic strains, such as Lactobacillus rhamnosus, Lactobacillus paracasei, Lactobacillus acidophilus, Bifidobacterium longum, Bifidobacterium bifidum, Bifidobacterium breve, Bifidobacterium animalis subsp. lactis and Bifidobacterium infantis are widely used in fermented milk products.

These probiotic strains, when inoculated in milk as single strains, grow very slow. In addition, some strains are not able to acidify below pH 6.0 in 24 h, see, e.g., FIG. 1, which shows that BB-12® and LGG® (BB-12® and LGG® are registered trademarks of Chr. Hansen A/S), respectively, do not grow/acidify well when they are inoculated without the yogurt culture. In combination with a yogurt culture, probiotic strain(s) can grow slightly better than as a single strain, but rarely grow more than 1 log. Due to taste and flavor desired by consumers, typical yogurt fermentation is stopped at pH 4.60-4.55. In addition, for safety reasons, it is important to achieve low pH, for example pH below approximately 5.5, such as pH 4.60-4.55. At this point (pH 4.60-4.55) yogurt species, Streptococcus thermophilus (ST) and Lactobacillus delbrueckii subsp. bulgaricus (LB) dominate over probiotic strain(s). Generally, final probiotic yogurt contains around 5 E+08 to 1 E+09 CFU/mL of ST and LB, and from 2-3 E+07 to 1 E+08 CFU/mL of a probiotic strain.

In addition, over shelf life (i.e., storage over 50-60 days, which is a typical shelf life of fresh fermented products in North America and some other regions in the world) in a typical probiotic yogurt, cell count of probiotics is reduced. For instance, over shell life, cell count of Bifidobacterium, BB-12® is usually reduced from 0.5-1 log over 50-60 days, depending on the yogurt culture, milk base, cultivation and storage conditions. Cell count of LA-5® (LA-5® is a registered trademark of Chr. Hansen A/S) is typically reduced from 1-2 logs over 50-60 days shelf life.

There are demands on certain markets, or certain type of products, to achieve probiotic counts higher than it is achievable by blends of a traditional yogurt culture and a probiotic strain(s) (2-3 E+07-1 E+08 CFU (colony forming units)/mL), in particular wherein the cell counts are maintained over the shelf life of the products. Examples of these products are:

1) Fermented probiotic shots in which documented level of probiotics (1E+09 CFU/serving) should be present in 65 ml of a product, after 60 days of shelf life;

2) Probiotic yogurt in which documented level of probiotics (1E+09 CFU/serving) is present for longer than 50-60 days;

3) Probiotic yogurt with very high counts (10-20E+09 CFU/serving); and

4) Freeze-dried yogurt ‘pearls’ (pellets) and drops (wafers). Probiotic yogurt that goes into this application must contain very high cell count of a probiotic strain (5E+08 CFU/g) to ensure effective dose (1E+09 CFU/serving at the end of shelf life) after processing, freezing and lyophilization.

Specially designed culture and combination of strains can support growth of, e.g., Bifidobacterium, BB-12® up to 1-2E+08 CFU/mL (see, e.g., WO 2008/148561). Higher counts of some probiotic strains can also be achieved by increased inoculation rates (5-10 times higher, 0.05%-0.1%), but this solution is costly and almost never used.

WO 2017/125600 shows that the co-cultivation of Lactose (−) Sucrose (+) S. thermophilus (ST) in combination with L. paracasei CRL 431 under specific conditions resulted in increased cell counts of L. paracasei CRL 431 as compared to the co-cultivation of Lactose (+) S. thermophilus (ST) in combination with L. paracasei CRL 431.

There is a need for further compositions and methods for producing fermented milk products with increased cell counts of viable probiotic cells such as Bifidobacterium animalis ssp. Lactis, BB-12®, Lactobacillus acidophilus, LA-5®, or Lactobacillus rhamnosus, LGG®, in particular wherein the viable cell counts are increased over the shelf life of the fermented milk product, which is typically 60 days, preferably at 4° C.

### SUMMARY OF THE INVENTION

The present invention is based on the surprising experimental finding that when using:

a) a starter culture comprising at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain; and

b) one or more non-lactose carbohydrate(s) capable of being metabolized by the lactic acid bacteria as defined in a), wherein the non-lactose carbohydrate(s) is(are) present in the composition in an amount measured so as to become depleted when the pH of the fermented milk product is between 4.9 and 5.5, such as between 5.0 and 5.4, preferably about 5.3 (e.g., about 0.41% sucrose, wherein % is weight per volume of the total amount of milk base (% w/v), and when the milk base comprises about 2 weight (wt.) % fat and about 4.1 wt. % protein, the starter culture in a) is added preferably as frozen concentrated culture in an amount of about 0.01% weight per volume of the total amount of milk base (% w/v) and the fermentation temperature is about 38° C.), in the fermentation of a milk base in the presence of a probiotic strain selected from the group consisting of Lactobacillus strain and a Bifidobacterium strain, the amounts of the probiotic bacteria present in the fermented milk product are increased as compared to the amount of probiotic bacteria present in a fermented milk product fermented:
only with the probiotic bacteria (as stated above, probiotic strains, when inoculated in milk as single strains, grow very slow, see also FIG. 1), or
with a starter culture comprising at least one Streptococcus thermophilus strain, which is not lactose-deficient, and at least one Lactobacillus strain which is not lactose-deficient, e.g., Lactobacillus delbrueckii subsp. bulgaricus strain (traditional Lactose (+) yogurt culture), or
with a starter culture comprising at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, such as a lactose-deficient Lactobacillus delbrueckii subsp. bulgaricus strain, in the presence of sucrose in an amount measured so as to become depleted when the pH of the fermented milk is lower than 4.9, such as about 4.55 (e.g., 0.9% sucrose, wherein % is weight/volume percent (w/v %) based on milk base, when the milk base comprises about 2 wt. % fat and about 4.1 wt. % protein, the starter culture is added preferably as frozen concentrated culture in an amount of 0.01% w/v of the total amount of milk base and the fermentation temperature is 38° C.).

In addition, there is an improved or increased survival of probiotic cells over time, e.g., over at least 60 days shelf life (storage) at about 4° C. The increase in the amounts of the viable probiotic bacteria present in the fermented milk product is maintained over time, e.g., immediately after fermentation has been completed, preferably over more than 1 day after fermentation is completed, such as more than 15 days, or more than 45 days, even over more than 60 days after fermentation has been completed. Accordingly, the total cell count of the viable probiotic strains in the presence of the starter culture of the invention as defined in a) above is increased as compared with the total cell count of the viable probiotic strains in the absence of the starter culture of the invention as defined in a) above, and this increase is maintained over time, e.g., after 60 days of storage (shelf life), preferably at about 4° C.

Accordingly, the present invention provides a process for producing a fermented milk product comprising the steps of:

i. Adding to a milk base:
a. a starter culture of lactic acid bacteria comprising at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain;
b. one or more non-lactose carbohydrate capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
c. a probiotic strain selected from the group consisting of Lactobacillus strain and a Bifidobacterium strain;

ii. and fermenting the milk base for a period of time until a target pH (preferably from about 4.8 to about 4.0, more preferably from about 4.6 to about 4.3, even more preferably about 4.55) is reached to obtain a fermented milk product.

The present invention further provides a fermented milk product produced by the process of the invention, and a food or feed product comprising at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain, and a probiotic strain selected from the group consisting of Lactobacillus strain and a Bifidobacterium strain, preferably wherein the probiotic Lactobacillus strain is not a Lactobacillus paracasei strain, even more preferably wherein the probiotic Lactobacillus strain is not L. paracasei strain CRL 431, deposited as ATCC 55544 or L. paracasei strain CHCC 2115, deposited as DSM 19465, wherein the food or feed product comprises more than 1.3E+08 CFU of probiotic bacteria/g of fermented milk product (CFU/g), preferably more than 2E+08 CFU/g, even more preferably more than 5E+08 CFU/g of the probiotic strain after fermentation, preferably after at least 1 day of storage at about 4° C.

Further, the present invention provides compositions for producing a fermented milk product comprising:

a) a starter culture of lactic acid bacteria comprising at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, such as a lactose-deficient Lactobacillus delbrueckii subsp. bulgaricus strain; and

b) one or more non-lactose carbohydrate capable of being metabolized by the lactic acid bacteria as defined in a), wherein the non-lactose carbohydrate(s) is(are) present in the composition in an amount measured so as to become depleted when the pH of the fermented milk product is between 4.9 and 5.5, such as between 5.0 and 5.4, preferably about 5.3.

In addition, the present invention provides the use of the composition of the present invention for increasing the number of viable probiotic cell counts in a fermented milk product, or for improving the survival of the probiotic cells over time, preferably over 60 days, preferably at 4° C., as compared to a fermented milk product fermented with a composition comprising

a) a starter culture of lactic acid bacteria comprising at least one Streptococcus thermophilus strain, which is not lactose-deficient, and at least one Lactobacillus strain which is not lactose-deficient, preferably a L. delbrueckii subsp. bulgaricus strain which is not lactose-deficient; and/or

b) i. a starter culture of lactic acid bacteria comprising at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain, and
ii. one or more non-lactose carbohydrate(s) capable of being metabolized by the lactic acid bacteria as defined in i), wherein the non-lactose carbohydrate(s) is(are) present in the composition in an amount measured so as to become depleted when the pH of the fermented milk product is between 4.9 and 5.5, such as between 5.0 and 5.4, preferably about 5.3.

### BRIEF DESCRIPTION OF THE FIGURES

FIG. 1. Acidification profile of Bifidobacterium, BB-12® (Bifidobacterium animalis subsp. lactis strain, BB-12® deposited as DSM 15954) (BB-12®, A, solid line) and L. rhamnosus, LGG® (Lactobacillus rhamnosus strain, LGG®, deposited as ATCC 53103) (LGG®, A, dashed line), inoculated in milk base at 0.01% and incubated at 38° C.

FIG. 2. Acidification profile of combination of Acidifix® 1.0 (Acidifix® is a registered trademark of Chr. Hansen A/S) and Bifidobacterium, BB-12® (Bifidobacterium animalis subsp. lactis strain, BB-12®, deposited as DSM 15954) (“Acidifix® 1.0, BB-12®”, dotted line), Acidifix® 1.0, BB-12® and LA-5° (Lactobacillus acidophilus strain, LA-5®, deposited as DSM 13241) (“Acidifix® 1.0, BB-12® and LA-5®”, solid line) or Acidifix® 1.0, BB-12® and L. rhamnosus, LGG® (Lactobacillus rhamnosus strain, LGG®, deposited as ATCC 53103) (“Acidifix® 1.0, BB-12® and LGG®”, dashed line), inoculated in milk base and incubated at 38° C.

FIG. 3. Acidification profiles of Acidifix® 1.0+0.01% BB-12® in milk with 0.41% (B) and 0.90% sucrose (D). YoFlex® Mild® 1.0+0.01 BB-12® (E) was used as a control (YoFlex® Mild is a registered trademark of Chr. Hansen A/S). % of sucrose is (w/v) based on milk base.

### DETAILED DISCLOSURE OF THE INVENTION

### Process for Producing a Fermented Milk Product

The present invention relates to a process for producing a fermented milk product comprising the steps of:

i. Adding to a milk base:
a. a starter culture of lactic acid bacteria (LAB) comprising at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain;
b. one or more non-lactose carbohydrate(s) capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
c. a probiotic strain selected from the group consisting of Lactobacillus strain and a Bifidobacterium strain;

ii. fermenting the milk base for a period of time until a target or desired pH is reached to obtain a fermented milk product.

In the context of the present invention in any of its embodiments, the expression “fermented milk product” means a food or feed product wherein the preparation of the food or feed product involves fermentation of a milk base with a lactic acid bacterium. “Fermented milk product” as used herein includes but is not limited to products such as thermophilic fermented milk products, e.g., yoghurt, drinking yoghurt, stirred yoghurt, set yoghurt and a yoghurt like drink. For instance, the yoghurt may be strained to remove most of the whey, resulting in a thicker consistency than unstrained yoghurt (“strained” or “high solids” yoghurt).

In the context of the present invention in any of its embodiments, the term “milk” is to be understood in the context of the present invention as the lacteal secretion obtained by milking of any mammal, such as cows, sheep, goats, buffaloes or camels. In a preferred embodiment, the milk is cow's milk. In accordance with the present invention the milk may have been processed and the term “milk” includes whole milk, skim milk, fat-free milk, low-fat milk, full fat milk, lactose-reduced milk (e.g. ultra-filtered (UF'd) milk, as long as lactose is not digested by lactase enzyme into glucose and galactose), or concentrated milk. Fat-free milk is non-fat or skim milk product. Low-fat milk is typically defined as milk that contains from about 1% to about 2% fat. Full fat milk often contains 2% fat or more. The term “milk” is intended to encompass milks from different sources. Mammal sources of milk include, but are not limited to cow, sheep, goat, buffalo, camel, llama, mare and deer.

The term “milk base” may be any milk material that can be subjected to fermentation according to the present invention. Thus, useful milk bases include, but are not limited to, fractions and solutions/-suspensions of any milk or milk like products comprising protein, such as whole or low-fat milk, skim milk, buttermilk, reconstituted milk powder, condensed milk, dried milk, whey, whey permeate, lactose, mother liquid from crystallization of lactose, whey protein concentrate, or cream. Obviously, the milk base may originate from any mammal, e.g., being substantially pure mammalian milk, or reconstituted milk powder.

In a preferred embodiment of the invention, the milk base to which the a starter culture (i.a.), non-lactose carbohydrate (i.b.) and probiotic strain(s) (i.c.) in step i of the process of the present invention are added has a content of lactose of between 30.0 mg/ml and 70 mg/ml, preferably between 35 mg/ml and 65 mg/ml, more preferably between 40 mg/ml and 60 mg/ml, and most preferably between 50 mg/ml and 60 mg/ml. The level of lactose is not essential. Lactose can be added to the milk base, but only a portion will be fermented by the probiotics.

Preferably, the milk base comprises at least about 2.5 wt. % protein, preferably from about 2.9 to about 4.5 wt. % protein, even more preferably, from about 4 to about 4.5 wt. % protein, such as about 4.1 wt. % protein. These amounts of protein in the milk base result in a good stirred or drinking yogurt. Preferably, the milk base comprises from about 0 to about 3.8 wt. % fat, such as from about 0.5 to about 3.25 wt. % fat. More preferably, the milk base comprises about 2 wt. % fat. In a preferred embodiment, the milk base comprises about 2 wt. % fat and about 4.1 wt. % protein.

Prior to fermentation, the milk base may be homogenized and pasteurized according to methods known in the art.

“Homogenizing” as used in the context of the present invention in any of its embodiments, means intensive mixing to obtain a soluble suspension or emulsion. If homogenization is performed prior to fermentation, it may be performed so as to break up the milk fat into smaller sizes so that it no longer separates from the milk. This may be accomplished by forcing the milk at high pressure through small orifices.

“Pasteurizing” as used in the context of the present invention in any of its embodiments, means treatment of the milk base to reduce or eliminate the presence of live organisms, such as microorganisms. Preferably, pasteurization is attained by maintaining a specified temperature for a specified period of time. The specified temperature is usually attained by heating. The temperature and duration may be selected in order to kill or inactivate certain bacteria, such as harmful bacteria. A rapid cooling step may follow. For instance, milk base may be heat treated at 92° C. for 3 min, cooled to 38° C. and then inoculated as described in step i. of the process of the present invention.

Step i. of the process of the present invention comprises adding to the milk base:

a. a starter culture of lactic acid bacteria (LAB) comprising at least one lactose-deficient Streptococcus thermophilus strain, which is capable of metabolizing a non-lactose carbohydrate and at least one lactose-deficient Lactobacillus strain, which is capable of metabolizing a non-lactose carbohydrate, such as a lactose-deficient Lactobacillus delbrueckii subsp. bulgaricus strain.

Preferably, the starter culture comprises two lactose-deficient Streptococcus thermophilus strain, which are capable of metabolizing a non-lactose carbohydrate and one lactose-deficient Lactobacillus strain, which is capable of metabolizing a non-lactose carbohydrate, preferably one lactose-deficient Lactobacillus delbrueckii subsp. bulgaricus strain.

The addition of strains to the milk base can also be referred to in the context of the present invention as “inoculation”.

In the context of the present invention in any of its embodiments, the expression “lactic acid bacteria” (“LAB”) designates food-grade bacteria producing lactic acid as the major metabolic end-product of carbohydrate fermentation. These bacteria are related by their common metabolic and physiological characteristics and are usually Gram positive, low-GC, acid tolerant, non-sporulating, non-respiring, rod-shaped bacilli or cocci. During the fermentation stage, the consumption of carbohydrate by these bacteria causes the formation of lactic acid, reducing the pH and leading to the formation of a protein coagulum. These bacteria are thus responsible for the acidification of milk and for the texture of the dairy product. The industrially most useful lactic acid bacteria are found within the order “Lactobacillales” which includes Lactococcus spp., Streptococcus spp., Lactobacillus spp., Leuconostoc spp., Pediococcus spp. and Propionibacterium spp. These are frequently used as food cultures alone or in combination with other lactic acid bacteria.

Lactic acid bacteria, including bacteria of the species Lactobacillus sp. and Streptococcus sp., are normally supplied to the dairy industry either as frozen (F-DVS) or freeze-dried (FD-DVS) cultures for bulk starter propagation or as so-called “Direct Vat Set” (DVS) cultures, intended for direct inoculation into a fermentation vessel or vat for the production of a dairy product, such as a fermented milk product. Such lactic acid bacterial cultures are in general referred to as “starter cultures” or “starters”. Typically, a starter culture for yogurt comprises Streptococcus thermophilus (also referred to herein as “ST” or “St”) and Lactobacillus delbrueckii subsp. bulgaricus (also referred to herein as “LB” or “Lb”), and in most countries a yogurt is by legislation defined as a fermented milk product produced using a starter culture comprising the two said strains.

The starter culture of lactic acid bacteria (LAB) according to the present invention in any of its embodiments comprises or, alternatively, consists of, at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain. Starter cultures are responsible for the acidification of the milk base. Starter cultures may be fresh, frozen or freeze-dried.

For the production of a fermented dairy product, the starter culture can be added in any amount. Typically, the starter culture is added in an amount to achieve a concentration from 0.001 to 3%, such as 0.05%, 0.01%, 0.015%, 0.02%, 1%, 2%, 3%, preferably from 0.001 to 0.025%, wherein % is weight per volume of the total amount of milk base (% w/v), such as from 0.0015 to 0.15% w/v, such as from 0.01 to 0.015% w/v, or from 0.01 to 0.02% w/v, or from 0.01 to 0.025% w/v of the total amount of milk base. Preferably, the starter culture is added as frozen concentrated culture in an amount from 0.01% w/v to 0.04% w/v of the total amount of milk base, such as 0.01% w/v or 0.02% w/v. Frozen concentrated cultures typically contain from 6E+10 to 1.5E+11 CFU/g. Alternatively, the starter culture is added as freeze-dried culture in an amount from 0.001 to 0.0025% w/v of the total amount of milk base. More preferably, the starter culture is added as frozen concentrated culture in an amount to achieve a concentration of about 0.01% weight per volume (% w/v) of the total amount of milk, preferably wherein the milk has a fat content of about 2 wt. % and a protein content of about 4.1 wt. %.

In a preferred embodiment, the starter culture is added to the milk base in an amount of from about 1E+06 to about 1E+08 CFU/ml of milk base (total amount of bacteria, i.e., the at least one lactose-deficient Streptococcus thermophilus strain, which is capable of metabolizing a non-lactose carbohydrate and the at least one lactose-deficient Lactobacillus strain, which is capable of metabolizing a non-lactose carbohydrate), preferably in an amount of from about 5E+06 to about 1E+07 CFU/ml of milk base, such as from about 6E+06 CFU/ml to about 1.5E+07 CFU/ml, even more preferably in an amount of from about 1.2 to about 1.3E+07 CFU/ml, preferably when the milk base has a fat content of about 2 wt. % fat and about 4.1 wt. % protein.

As disclosed in WO 2005/003327, it is beneficial to add certain cryoprotective agents to a starter culture. Thus, the starter culture of step i.a. of the process of the present invention may comprise one or more cryoprotective agent(s) selected from the group consisting of inosine-5′-monophosphate (IMP), adenosine-5′-monophosphate (AMP), guanosine-5′-monophosphate (GMP), uranosine-5′-monophosphate (UMP), cytidine-5′-monophosphate (CMP), adenine, guanine, uracil, cytosine, adenosine, guanosine, uridine, cytidine, hypoxanthine, xanthine, hypoxanthine, orotidine, thymidine, inosine and a derivative of any such compounds.

The terms “deficiency in lactose metabolism” and “lactose deficient” are used in the context of the present invention in any of its embodiments to characterize LAB which either partially or completely lost the ability to use lactose as a source for cell growth or maintaining cell viability. Respective LAB are capable of metabolizing one or several carbohydrates selected from sucrose, galactose and/or glucose, or any another fermentable carbohydrate. Since these carbohydrates are not naturally present in milk in sufficient amounts to support fermentation by lactose deficient mutants, it is necessary to add these carbohydrates to the milk. Lactose-deficient and partially lactose-deficient LAB can be characterized as white colonies on a medium containing lactose and X-Gal. Lactose deficient LAB and methods of producing the same have been generally described, exemplified and deposited in prior published patent applications, including WO 2013/160413, PCT/EP2015/063767 and PCT/EP2015/063742, which describe methods for producing LAB with a deficiency in lactose metabolism and specific strains obtained by these methods.

The term “capable of metabolizing one or several carbohydrates other than lactose present in the milk” is used in the context of the present invention in any of its embodiments to describe the metabolic activity of lactose deficient LAB which causes production of lactic acid as the major metabolic end-product of carbohydrate fermentation using a carbohydrate other than lactose.

In a particular embodiment of the invention, the lactose-deficient strain(s) is(are) capable of metabolizing one or more non-lactose carbohydrates selected from the group consisting of sucrose, galactose and glucose, preferably sucrose. In a particular embodiment of the invention, the lactose-deficient strain(s) is(are) capable of metabolizing galactose.

In a preferred embodiment, the at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain, which are comprised in the starter culture which is added to the milk base in step a of the present invention, are capable of metabolizing the same non-lactose carbohydrate, which is preferably sucrose. In other embodiments, the at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain, which are comprised in the starter culture which is added to the milk base in step a of the present invention, are capable of metabolizing different non-lactose carbohydrates, preferably wherein the non-lactose carbohydrate is not glucose. For example, the at least one lactose-deficient Streptococcus thermophilus strain is capable of metabolizing sucrose and the at least one lactose-deficient Lactobacillus strain is capable of metabolizing galactose, or vice versa.

Preferably, the Streptococcus thermophilus lactose-deficient strain is selected from the group consisting of:
(a) (i) the strain deposited with DSMZ-Deutsche Sammlung von Mikroorganismen and Zellkulturen GmbH, Inhoffenstr. 7B, D-38124 Braunschweig, on 2014 Jun. 12 under the accession no. DSM 28952;
   (ii) a strain derived from DSM 28952, wherein the derived strain is further characterized as having the ability to generate white colonies on a medium containing lactose and X-Gal;
(b) (i) the strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28953;
   (ii) a strain derived from DSM 28953, wherein the derived strain is further characterized as having the ability to generate white colonies on a medium containing lactose and X-Gal;
(c) (i) the strain deposited with DSMZ-Deutsche Sammlung von Mikroorganismen und Zellkulturen GmbH, Inhoffenstr. 7B, D-38124 Braunschweig, on 2017 Aug. 22 under the accession no. DSM 32599;
   (ii) a strain derived from DSM 32599, wherein the derived strain is further characterized as having the ability to generate white colonies on a medium containing lactose and X-Gal; and
(d) (i) the strain deposited with DSMZ-Deutsche Sammlung von Mikroorganismen und Zellkulturen GmbH, Inhoffenstr. 7B, D-38124 Braunschweig, on 2017 Aug. 22 under the accession no. DSM 32600; and
   (ii) a strain derived from DSM 32600, wherein the derived strain is further characterized as having the ability to generate white colonies on a medium containing lactose and X-Gal.

Preferably, the lactose-deficient Lactobacillus strain present in the starter culture is a lactose-deficient Lactobacillus delbrueckii subsp. bulgaricus strain. More preferably, the lactose-deficient Lactobacillus delbrueckii subsp. bulgaricus strain is selected from the group consisting of:
(i) the strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28910; and
(ii) a strain derived from DSM 28910, wherein the derived strain is further characterized as having the ability to generate white colonies on a medium containing lactose and X-Gal.

In the context of the present invention in any of its embodiments, “a strain derived from” or “a strain which can be derived from” (“strains derived therefrom”) or “mutant” means strains which have been obtained from other strains (e.g., the above-indicated deposited strains) by means of, e.g., genetic engineering, radiation and/or chemical treatment. The “strains derived therefrom” or “mutants” can also be spontaneously occurring mutants. It is preferred that the “strains derived therefrom” or “mutants” are functionally equivalent mutants, e.g. mutants that have substantially the same, or improved properties as their mother strain. For instance, the derived strain or mutant is further characterized as having the ability to generate white colonies on a medium containing lactose and X-Gal. Especially, “strains derived therefrom” or “mutants” refers to strains obtained by subjecting a strain of the invention (e.g., the above-indicated deposited strains) to any conventionally used mutagenization treatment including treatment with a chemical mutagen such as ethane methane sulphonate (EMS) or N-methyl-N′-nitro-N-nitroguanidine (NTG), UV light, or to a spontaneously occurring mutant. A mutant may have been subjected to several mutagenization treatments (a single treatment should be understood as one mutagenization step followed by a screening/selection step), but it is presently preferred that no more than 20, or no more than 10, or no more than 5, treatments (or screening/selection steps) are carried out. In a presently preferred mutant less than 1%, less than 0.1%, less than 0.01%, less than 0.001% or even less than 0.0001% of the nucleotides in the bacterial genome have been replaced with another nucleotide, or deleted, compared to the mother strain.

In a preferred embodiment of the present invention the at least one lactose-deficient Streptococcus thermophilus strain, which is capable of metabolizing a non-lactose carbohydrate, and/or the at least one lactose-deficient Lactobacillus strain which is capable of metabolizing a non-lactose carbohydrate, preferably L. delbrueckii subsp. bulgaricus, is(are) a proteolytic strain(s), preferably a highly proteolytic strain(s).

In the context of the present invention in any of its embodiments, a LAB is a “proteolytic LAB” if it contains an active cell wall proteinase. A cell wall proteinase hydrolyzes milk proteins, such as casein, and thus improves the quality of milk as a medium for rapid growth of LAB having amino acid auxotrophies. Cell wall proteinases have been identified and characterized in detail in numerous LAB, including the PrtP of L. lactis, the PrtS of S. thermophilus and the PrtB of Lactobacillus delbrueckii subsp. bulgaricus (Lb. bulgaricus). Proteolytic LAB can thus be identified by the presence of the gene encoding the cell wall proteinase. Additionally, proteolytic LAB can be identified by the fluorescent substrate fluorescein isothiocyanate labeled casein or FITC casein assay, wherein an increase in fluorescence caused by the growth of the strain for 6 hours in a medium containing fluorescently labeled casein in comparison to control samples without cells of the strain is determined. Full details of the assay are provided, e.g., in Example 1 of WO 2017/125600.

Preferably, the at least one lactose-deficient Streptococcus thermophilus strain, which is capable of metabolizing a non-lactose carbohydrate, is added to the milk base in step i.a. of the process of the present invention in an amount from 1E+04 to 1E+10 CFU (colony forming units)/ml of milk base, preferably from 1E+05 to 1E+10 CFU/ml, or from 1E+06 to 1E+10 CFU/ml, or from 1E+07 to 1E+09 CFU/ml, preferably when the milk base has a fat content of about 2 wt. % fat and about 4.1 wt. % protein. More preferably, the at least one lactose-deficient Streptococcus thermophilus strain, which is capable of metabolizing a non-lactose carbohydrate, preferably sucrose, is added to the milk base in step i.a. of the process of the present invention in an amount from 1E+06-1E+08 CFU/ml of milk base, preferably when the milk base has a fat content of about 2 wt. % fat and about 4.1 wt. % protein.

Preferably, the at least one Lactobacillus strain which is capable of metabolizing a non-lactose carbohydrate, preferably L. delbrueckii subsp. bulgaricus, is added to the milk base in step i.a. of the process of the present invention in an amount from 1E+04 to 1E+10 CFU/ml of milk base, preferably from 1E+05 to 1E+10 CFU/ml, or from 1E+06 to 1E+10 CFU/ml, or from 1E+07 to 1E+09 CFU/ml, preferably when the milk base has a fat content of about 2 wt. % fat and about 4.1 wt. % protein. More preferably, the at least one Lactobacillus strain which is capable of metabolizing a non-lactose carbohydrate, preferably L. delbrueckii subsp. bulgaricus, is added to the milk base in step i.a. of the process of the present invention in an amount from 1E+06-1E+08 CFU/ml of milk base, preferably when the milk base has a fat content of about 2 wt. % fat and about 4.1 wt. % protein.

As described above, in a preferred embodiment of the present invention, the at least one lactose-deficient Streptococcus thermophilus strain, which is capable of metabolizing a non-lactose carbohydrate and the at least one lactose-deficient Lactobacillus strain, which is capable of metabolizing a non-lactose carbohydrate are added to the milk base (“inoculation dose”), which preferably has a fat content of about 2 wt. % fat and about 4.1 wt. % protein, in a total amount of from about 1E+06 to about 1E+08 CFU/ml of milk base, preferably in a total amount of from about 5E+06 to about 1E+07 CFU/ml of milk base, such as about 6E+06 CFU/ml to about 1.5E+07 CFU/ml, even more preferably in a total amount of from about 1.2E+07 CFU/ml to about 1.3E+07 CFU/ml.

The ratio of bacterial cell counts of the at least one lactose-deficient Streptococcus thermophilus strain, which is capable of metabolizing a non-lactose carbohydrate (ST) and the least one lactose-deficient Lactobacillus strain, which is capable of metabolizing a non-lactose carbohydrate, preferably L. delbrueckii subsp. bulgaricus (LB) (ST:LB) in the starter culture or the milk base at the beginning of fermentation can be easily determined by one of ordinary skill. In a particular embodiment, the ratio is in the range of 99:1 to 1:99, such as 95:5 to 5:95, 80:20 to 20:80, or 70:30 to 30:70, or 60:40 to 40:60, or 50:50 (ST:LB). A preferred ratio is in the range of 90:10 to 99:1 (ST:LB).
b. a non-lactose carbohydrate capable of being metabolized by the lactic acid bacteria as defined in a.

In the context of the present invention in any of its embodiments, the term “non-lactose carbohydrate” means any carbohydrate, which is not lactose, and which a lactose-deficient LAB of the invention is capable of metabolizing. In a particular embodiment of the invention, the non-lactose carbohydrate is selected from the group consisting of sucrose, galactose and glucose. Preferably, the non-lactose carbohydrate is not glucose. Even more preferably, the non-lactose carbohydrate is sucrose.

The non-lactose carbohydrate(s) is(are) added to the milk base in an amount measured so as to become depleted when the pH of the fermented milk product is between 4.9 and 5.5, such as between 5.0 and 5.4, preferably when the pH of the fermented milk product is about 5.3. Acidification profile of the milk base can be followed by standard means known to the skilled person, such as, e.g., on-line pH measurement equipment.

In the context of the present invention in any of its embodiments, the term “depletion” in relation to non-lactose carbohydrate(s) means that the concentration of the non-lactose carbohydrate(s) is zero or so low that the starter culture as defined in step i.a. is no longer capable of growing, or so low that the starter culture as defined in step i.a. is no longer capable of further acidifying the milk base. Of note, growth and acidification rate/profile are directly correlated. Indication of absence of growth of the yogurt starter culture is shown on the acidification profile. Once the fermentable carbohydrate(s) (e.g., sucrose) is(are) depleted, there is a break in the acidification curve. From that point on, the slope/shape of the curve is changed, indicating that only another portion (probiotic) of the culture mix is growing. The lack of growth of the starter culture of step a of the process of the invention can also be determined, e.g., by plating of ST (Streptococcus thermophilus) strains. In a particular embodiment of the invention, at the termination of fermentation the concentration of the non-lactose carbohydrate at which it is “depleted” can be in the range of less than 100 mg/g, such as less than 30 mg/g, including a range between 25 mg/g and 0.01 mg/g, or a range between 5 mg/g 0.01 mg/g.

In this context, when the pH of the fermented milk product is between 4.9 and 5.5, such as between 5.0 and 5.4, preferably when the pH of the fermented milk product is about 5.3, the fermentation due to the metabolism of the starter culture ends. According to the present invention, the fermentation of the starter culture is thus terminated by depletion of the one or more non-lactose carbohydrate(s). However, since the milk base further comprises probiotic strains, which are able to metabolize carbohydrates present in the composition, such as lactose, fermentation due to the metabolism of the probiotic strains would continue. In fact, in the context of the present invention, the fermentation of the milk base due to the metabolism of the probiotic strains, preferably a probiotic strain selected from the group consisting of Lactobacillus strain and a Bifidobacterium strain, see below, is desired, and will preferably happen according to step ii. of the process of the present invention.

Accordingly, the fermentation of the milk base due to the metabolism of the starter culture (catabolism of the non-lactose carbohydrate(s)) will stop at a pH of between 4.9 and 5.5, such as between 5.0 and 5.4, preferably about 5.3, because the non-lactose carbohydrate(s) has(have) been depleted, and the starter culture is essentially no longer capable of growing/acidifying the milk base. However, since the milk base comprises further strains, i.e., a probiotic strain selected from the group consisting of Lactobacillus strain and a Bifidobacterium strain, which is/are able to metabolize one or more of the carbohydrates still present in the milk base, such as lactose, the fermentation of the milk base will continue, see below.

The amount of non-lactose carbohydrate(s) to be added to the milk base depends on a number of parameters, including the lactic acid bacteria strains used in the starter culture, the composition of the milk base, the fermentation temperature and the desired target pH, which in the present case is between 4.9 and 5.5, such as between 5.0 and 5.4, preferably about 5.3. The amount of non-lactose carbohydrate(s) to be added to the milk base can be determined by experimentation, and it is within the skills of a skilled person to carry out such experimentation. Accordingly, the skilled person is able to calculate the amount of non-lactose carbohydrate(s), preferably sucrose, which should be added to the milk base in step i.b. of the process of the present invention so that the starter culture added in step i.a. stops growing because the non-lactose carbohydrate(s) has(have) been depleted when the pH of the fermented milk product is between 4.9 and 5.5, such as between 5.0 and 5.4, preferably when the pH of the fermented milk product is about 5.3.

The amount of non-lactose carbohydrate(s) can thus be easily determined on the basis of the LAB used and the desired acidification (target pH of between 4.9 and 5.5, such as between 5.0 and 5.4, preferably about 5.3) primarily caused by the starter culture comprising at least one lactose-deficient Streptococcus thermophilus strain, which is capable of metabolizing a non-lactose carbohydrate, and at least one lactose-deficient Lactobacillus strain which is capable of metabolizing a non-lactose carbohydrate, preferably L. delbrueckii subsp. bulgaricus. In most instances sucrose, galactose and/or glucose, preferably sucrose, are (is) added to the milk in an amount resulting in a concentration in the range of 0.4 g/L to 10 g/L, or in the range of 1 g/L to 8 g/L or in the range of 2 g/L to 6 g/L.

In a preferred embodiment, the non-lactose carbohydrate, which is preferably sucrose, is added to the milk base in step i.b. of the process of the present invention in an amount of less than 0.9% wherein % is weight per volume of the total amount of milk base (% w/v), preferably in an amount of less than 0.7%, even more preferably in an amount of less than 0.5%, such as 0.41%, preferably wherein the milk base comprises about 2 wt. % fat and about 4.1 wt. % protein, the starter culture in step i.a. is added preferably as frozen concentrated culture in an amount of 0.01% w/v (e.g., about 1.2-1.3E+07 CFU/ml) of the total amount of milk and the fermentation temperature is about 38° C.

For example, when the amount of starter culture added in step i.a. is 0.01% w/v (e.g., about 1.2-1.3E+07 CFU/ml), the non-lactose carbohydrate(s) added in step i.b., preferably sucrose, is(are) added in an amount of less than 0.9%, preferably in an amount of less than 0.7%, even more preferably in an amount of less than 0.5%, preferably between 0.5% and 0.41%, most preferably about 0.41%, wherein % is weight per volume (w/v) based on milk base (% w/v), preferably wherein the milk base comprises about 2 wt. % fat and about 4.1 wt. % protein and the fermentation temperature is about 38° C.
c. a probiotic strain selected from the group consisting of Lactobacillus strain and a Bifidobacterium strain.

In the context of the present invention in any of its embodiments, the term “probiotic bacteria” or “probiotic strain” refers to viable bacteria which are administered in adequate amounts to a consumer for the purpose of achieving a health-promoting effect in the consumer. Probiotic bacteria are capable of surviving the conditions of the gastrointestinal tract after ingestion and colonize the intestine of the consumer.

In a particular embodiment of the invention the probiotic strain according to the present invention is selected from the group consisting of bacteria of the genus Lactobacillus, such as Lactobacillus acidophilus, Lactobacillus paracasei, Lactobacillus rhamnosus, Lactobacillus paracasei, Lactobacillus delbrueckii, Lactobacillus lactis, Lactobacillus plantarum, Lactobacillus reuteri and Lactobacillus johnsonii, the genus Bifidobacterium, such as the Bifidobacterium longum, Bifidobacterium adolescentis, Bifidobacterium bifidum, Bifidobacterium breve, Bifidobacterium animalis subsp. lactis and Bifidobacterium infantis, and the like.

In a preferred embodiment, the probiotic Lactobacillus strain is selected from the group consisting of Lactobacillus acidophilus, Lactobacillus paracasei, Lactobacillus rhamnosus, Lactobacillus casei, Lactobacillus delbrueckii, Lactobacillus lactis, Lactobacillus plantarum, Lactobacillus reuteri and Lactobacillus johnsonii.

In a particular embodiment of the invention, the probiotic Lactobacillus strain is selected from the group consisting of a Lactobacillus rhamnosus strain, a Lactobacillus acidophilus strain and a Lactobacillus paracasei strain.

In a preferred embodiment of the invention, the probiotic strain is Lactobacillus rhamnosus strain, LGG®, deposited as ATCC 53103. In another preferred embodiment of the invention, the probiotic strain is Lactobacillus acidophilus strain, LA-5®, deposited as DSM 13241. In a particular embodiment of the invention, the probiotic strain is Lactobacillus paracasei strain CRL 431 deposited as ATCC 55544, which is commercially available. In a preferred embodiment, the probiotic Lactobacillus strain is not L. paracasei strain CRL 431, deposited as ATCC 55544 or L. paracasei strain CHCC 2115, deposited with the DSMZ-Deutsche Sammlung von Mikroorganismen and Zellkulturen GmbH, Inhoffenstr. 7B, D-38124 Braunschweig, on 2007 Jun. 27, under the accession number DSM 19465.

In a particular embodiment of the invention, the probiotic Bifidobacterium strain is selected from the group consisting of Bifidobacterium longum, Bifidobacterium adolescentis, Bifidobacterium bifidum, Bifidobacterium breve, Bifidobacterium animalis subsp. lactis and Bifidobacterium infantis.

In a particular embodiment of the invention, the probiotic Bifidobacterium probiotic strain is Bifidobacterium animalis subsp. lactis, BB-12®, also referred to as BB-12®, deposited with the DSMZ-Deutsche Sammlung von Mikroorganismen und Zellkulturen GmbH, Mascheroder Weg. 1b, D-38124 Braunschweig, on 2003 Sep. 30 under the accession number DSM 15954. The Bifidobacterium, BB-12®, is a well-known probiotic bacterium, obtainable from Chr. Hansen A/S, Horsholm, DK. In the case of BB-12® the available clinical evidence indicates that a daily dose of at least 1E+09-1E+10 CFU viable probiotic bacteria is required. Accordingly, it is desirable to have a high level of, e.g., 1E+08 CFU or more of probiotic bacteria per gram fermented milk product (e.g., a fermented milk yogurt product).

In a preferred embodiment, step i.c. comprises adding to the milk base a Bifidobacterium strain, preferably Bifidobacterium strain is selected from the group consisting of Bifidobacterium longum, Bifidobacterium adolescentis, Bifidobacterium bifidum, Bifidobacterium breve, Bifidobacterium animalis subsp. lactis and Bifidobacterium infantis, even more preferably, the addition to the milk base of Bifidobacterium animalis subsp. lactis, BB-12®, deposited with the DSMZ-Deutsche Sammlung von Mikroorganismen und Zellkulturen GmbH, Mascheroder Weg. 1b, D-38124 Braunschweig, on 2003 Sep. 30 under the accession number DSM 15954.

For example, step i.c. may comprise adding to the milk base a probiotic strain belonging to the genus Bifidobacterium, preferably belonging to the species Bifidobacterium animalis, even more preferably Bifidobacterium animalis subsp. lactis, BB-12®, as described above, and a probiotic strain belonging to the genus Lactobacillus, such as Lactobacillus rhamnosus and/or Lactobacillus acidophilus, preferably wherein the probiotic strain belonging to the genus Lactobacillus is not a L. paracasei strain, even more preferably wherein the probiotic Lactobacillus strain is not L. paracasei strain CRL 431, deposited as ATCC 55544 or L. paracasei strain CHCC 2115, deposited as DSM 19465.

Even more preferably, the composition of the invention comprises a probiotic strain belonging to the species Bifidobacterium animalis, preferably Bifidobacterium animalis subsp. lactis strain, BB-12®, deposited as DSM 15954, and a probiotic strain belonging to the species Lactobacillus rhamnosus, preferably strain, LGG®, deposited as ATCC53103 and/or a probiotic strain belonging to the species Lactobacillus acidophilus, preferably strain LA-5®, deposited as DSM 13241.

Preferably, the probiotic Bifidobacterium strain is added to the milk base in step i.c. of the process of the present invention in an amount from 1E+06 to 1E+08 CFU/ml of milk base, preferably from 5E+06 to 5E+07 CFU/ml, more preferably about 1.2E+07 CFU/ml of milk base.

Preferably, the probiotic strain is added to the milk base in step i.c. of the process of the present invention in an amount from 0.001 to 2%, wherein % is weight per volume of the total amount of milk base (% w/v), such as 0.005%, 0.01%, 0.015%, 0.02%, preferably from 0.001 to 0.025% weight per volume of the total amount of milk base, such as from 0.0015 to 0.15%, such as from 0.01 to 0.015%, or from 0.01 to 0.02%, or from 0.01 to 0.025% weight per volume of the total amount of milk base. Preferably, the probiotic strain is added to the milk base in an amount to achieve a concentration of about 0.01% weight per volume of the total amount of milk base, preferably wherein the probiotic strain is added as a frozen concentrated culture, preferably wherein the milk base has a fat content of about 2 wt. % and a protein content of about 4.1 wt. %. If the probiotic strain is added to the milk base in step i.c of the process of the present invention in an amount of about 0.001% weight per volume of the total amount of milk base, the probiotic strain is preferably added as freeze-dried concentrated culture.

In a preferred embodiment, the cell counts of BB-12® in milk upon inoculation at 0.01% of F-DVS are about 1.2E+07 CFU/ml. In a preferred embodiment, the cell counts of LA-5® in milk upon inoculation at 0.01% of F-DVS are about 7E+06 CFU/ml. In a preferred embodiment, the cell counts of LGG® in milk upon inoculation at 0.001% of FD-DVS is about 7E+06 CFU/ml.

Accordingly, in a preferred embodiment, step i. of the process of the present invention comprises adding to a milk base:
a. At least one lactose-deficient Streptococcus thermophilus strain, which is capable of metabolizing a non-lactose carbohydrate, and at least one lactose-deficient Lactobacillus strain which is capable of metabolizing a non-lactose carbohydrate, preferably at least one lactose-deficient L. delbrueckii subsp. bulgaricus strain, preferably in an amount of about 1.2-1.3E+07 CFU/ml;
b. One or more non-lactose carbohydrate(s) capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
c. Bifidobacterium animalis subsp. lactis, BB-12®, deposited as DSM 15954, preferably in an amount of about 1.2E+07 CFU/ml;

Or:
a. At least one lactose-deficient Streptococcus thermophilus strain, which is capable of metabolizing a non-lactose carbohydrate, and at least one lactose-deficient Lactobacillus strain which is capable of metabolizing a non-lactose carbohydrate, preferably at least one lactose-deficient L. delbrueckii subsp. bulgaricus strain, preferably in an amount of about 1.2-1.3E+07 CFU/ml;
b. One or more non-lactose carbohydrate(s) capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
c. Bifidobacterium animalis subsp. lactis, BB-12®, deposited as DSM 15954, preferably in an amount of about 1.2E+07 CFU/ml and Lactobacillus rhamnosus strain, LGG®, deposited as ATCC 53103, preferably in an amount of about 7E+06 CFU/ml;

Or:
a. At least one lactose-deficient Streptococcus thermophilus strain, which is capable of metabolizing a non-lactose carbohydrate, and at least one lactose-deficient Lactobacillus strain which is capable of metabolizing a non-lactose carbohydrate, preferably at least one lactose-deficient L. delbrueckii subsp. bulgaricus strain, preferably in an amount of about 1.2-1.3E+07 CFU/ml;
b. One or more non-lactose carbohydrate(s) capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
c. Bifidobacterium animalis subsp. lactis, BB-12®, deposited as DSM 15954 and Lactobacillus acidophilus strain, LA-5®, deposited as DSM 13241, preferably wherein BB-12® is added in an amount of about 1.2E+07 CFU/ml and LA-5® is added in an amount of about 7E+06 CFU/ml.

In these preferred embodiments described above, the at least one lactose-deficient Streptococcus thermophilus strain which is capable of metabolizing a non-lactose carbohydrate is preferably selected from the group consisting of:
(a) (i) the strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28952;
   (ii) a strain derived from DSM 28952, wherein the derived strain is further characterized as having the ability to generate white colonies on a medium containing lactose and X-Gal;
(b) (i) the strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28953;
   (ii) a strain derived from DSM 28953, wherein the derived strain is further characterized as having the ability to generate white colonies on a medium containing lactose and X-Gal;
(c) (i) the strain deposited with DSMZ-Deutsche Sammlung von Mikroorganismen und Zellkulturen GmbH, Inhoffenstr. 7B, D-38124 Braunschweig, on 2017 Aug. 22 under the accession no. DSM 32599;
   (ii) a strain derived from DSM 32599, wherein the derived strain is further characterized as having the ability to generate white colonies on a medium containing lactose and X-Gal; and
(d) (i) the strain deposited with DSMZ-Deutsche Sammlung von Mikroorganismen und Zellkulturen GmbH, Inhoffenstr. 7B, D-38124 Braunschweig, on 2017 Aug. 22 under the accession no. DSM 32600; and
   (ii) a strain derived from DSM 32600, wherein the derived strain is further characterized as having the ability to generate white colonies on a medium containing lactose and X-Gal.

Preferably, the lactose-deficient Lactobacillus strain present in the starter culture is a lactose-deficient Lactobacillus delbrueckii subsp. bulgaricus strain. Preferably, the lactose-deficient Lactobacillus delbrueckii subsp. bulgaricus strain is selected from the group consisting of:
(i) the strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28910; and
(ii) a strain derived from DSM 28910, wherein the derived strain is further characterized as having the ability to generate white colonies on a medium containing lactose and X-Gal.

As it will be understood by the skilled person, step i. of the process of the present invention comprises the addition to a milk base of i.a. (starter culture), i.b. (non-lactose carbohydrate(s)) and i.c. (probiotic strain). The order of the addition of these three elements is not relevant; e.g., the starter culture may be added first to the milk base, and then the non-lactose carbohydrate(s), and then the probiotic strain. Or the starter culture and the probiotic strain may be mixed together, and then added to the milk base which comprises the non-lactose carbohydrate(s) at the same time. Most preferably (i) the non-lactose carbohydrate(s) (preferably sucrose) is(are) first added to the milk base, and then (ii) the starter culture and the probiotic strain are added to the milk base, e.g., the starter culture and the probiotic strain are added at the same time, and at a time point after the non-lactose carbohydrate(s) has(have) been added to the milk base. Preferably, the non-lactose carbohydrate(s) (which is preferably sucrose) is(are) added into the milk base before heat treatment (e.g., pasteurization), if any, to ensure absence of contaminants.

Typically, frozen concentrated yogurt cultures and probiotics cultures (F-DVS) contain from 6E+10-1.5E+11 CFU/g. When inoculated at 0.01% w/v the cell counts in milk before incubation (before fermentation) are preferably from about 6E+06 CFU/ml to about 1.5E+07 CFU/ml. When inoculated at 0.02% w/v, the cell counts in milk before incubation (before fermentation) are preferably from about 1.2E+07 CFU/ml to about 3E+07 CFU/ml.

Step ii of the process of the present invention comprises fermenting the milk base for a period of time until a target (or desired) pH is reached, to obtain a fermented milk product.

“Fermentation” in the context of the present invention in any of its embodiments means the conversion of carbohydrates into alcohols or acids through the action of a microorganism. For example, fermentation in the context of the starter culture of the invention comprises conversion of a non-lactose carbohydrate, e.g., sucrose, to lactic acid.

In the context of step ii of the method of the present invention, fermentation comprises:
A first stage wherein fermentation is primarily due to the conversion of the non-lactose carbohydrate added to the milk base in step i.b., e.g., sucrose, to lactic acid by the starter culture of LAB comprising at least one lactose-deficient Streptococcus thermophilus strain, which is capable of metabolizing a non-lactose carbohydrate, and at least one lactose-deficient Lactobacillus strain, preferably L. delbrueckii subsp. bulgaricus strain, which is capable of metabolizing a non-lactose carbohydrate, added in step i.a.;
A second stage wherein fermentation is primarily due to the probiotic strain as defined in the context of present the invention, added to the milk base in step i.c., which involves the conversion of lactose to lactic acid by the probiotic strain.

In the process of the present invention, during the first stage of fermentation, the lactose-deficient strains would metabolize the non-lactose carbohydrate(s) until the non-lactose carbohydrate(s) is(are) depleted. As indicated above, in combination with a yogurt culture, probiotic strain(s) can grow slightly better than as a single strain, but still grow much slower than yogurt species, Streptococcus thermophilus (ST) and Lactobacillus delbrueckii subsp. bulgaricus (LB), which at this stage would dominate over the probiotic strain(s).

Since the amount of non-lactose carbohydrate(s) is(are) added in an amount measured so as to become depleted when the pH of the fermented milk product is between 4.9 and 5.5, such as between 5.0 and 5.4, preferably about 5.3, the first stage of fermentation will end when the pH of the milk is between 4.9 and 5.5, such as between 5.0 and 5.4, preferably about 5.3. At this stage, the lactose-deficient strains, which dominate over the probiotic strain(s), are not able to grow further, since they are essentially not able to metabolize lactose.

However, the probiotic strain(s) selected from the group consisting of Lactobacillus strain and a Bifidobacterium strain added to the milk base in step i.c. of the process of the present invention, which comprises probiotic strains able to metabolize lactose, will continue the acidification of the milk base. Accordingly, in the second step, the fermentation will be primarily due to the metabolic activity of the probiotic strain(s). The probiotic strains will consume the lactose present in the milk base and will continue the acidification until reaching a target (desired) pH. The target (desired) pH may between about 3.2 and below 4.9, preferably between about 3.6 and about 4.8, more preferably between about 4.0 and about 4.6, such as about 4.0, or about 4.3, or about 4.4 or about 4.5, preferably between about 4.6 and about 4.5, even more preferably about 4.55. In a preferred embodiment, the target (desired) pH is about 4.55.

This second fermentation step (and thus, the fermentation step ii of the present invention) can be terminated by any means known to the skilled person, such as a cooling treatment, or because the milk reaches a pH which renders the probiotic strain(s) unable to grow, or because the lactose in the milk is depleted and the probiotic strains are not able to grow further, etc. For instance, the fermentation step ii of the present invention can be terminated by cooling (e.g., about 4° C.) and the fermented milk product is cold storaged (e.g., at about 4° C.). Cooling is generally used as a mean to slow down metabolic activity and keep cultures and probiotics alive.

Fermentation processes to be used in production of dairy products are well known and the person of skill in the art will know how to select suitable process conditions, such as temperature, oxygen, amount and characteristics of microorganism(s) and process time. Obviously, fermentation conditions are selected so as to support the achievement of the present invention, e.g., to obtain a dairy product in solid (such as strained or high solids yogurt) or liquid form (such as yoghurt, drinking yogurt, stirred yogurt, set yogurt and a yogurt like drink). In the context of the present invention, the fermentation is carried out at a temperature between about 34° C. and about 43° C.—such as about 34° C., 35° C., 36° C., 37° C., 38° C., 39° C., 40° C., 41° C., 42° C., 43° C., preferably at about 38° C., about 40° C. or about 43° C.

In a preferred embodiment, the fermented milk product obtained by the process of the present invention comprises 1.3E+08 CFU of probiotic cells/g of fermented milk product (CFU/g) or more, preferably 2E+08 CFU/g or more, or 3E+08 CFU/g or more, or 4E+08 CFU/g or more, even more preferably 5E+08 CFU/g or more, such as 6E+08 CFU/g or more of at least one probiotic strain, e.g., immediately after fermentation, preferably at a time point which is at least 1 day after fermentation has been completed (i.e., fermentation step (ii) of the present invention) has been completed), such as 15 days, or 30 days, or 45 days, more preferably 60 days after fermentation has been completed, wherein preferably the food or feed product has been kept at about 4° C. after fermentation according to step ii of the process of the present invention has finalized (has been completed), preferably wherein the milk base comprises about 2 wt. % fat and about 4.1 wt. % protein, preferably wherein the fermentation takes place at about 38° C. and preferably until a pH of about 4.55 is reached.

### Fermented Milk Product

Further, the present invention provides a fermented milk product produced, obtained or directly obtained by the process of the present invention.

Advantageously, the fermented milk product of the present invention will comprise higher amounts of viable probiotic bacteria (higher amount of viable probiotic cell counts) as compared to the amount of viable probiotic bacteria present in a fermented milk product incubated only with the probiotic bacteria, or fermented with a starter culture comprising at least one Streptococcus thermophilus strain, which is not lactose-deficient, and at least one Lactobacillus strain, preferably L. delbrueckii subsp. bulgaricus, which is not lactose-deficient (e.g., traditional lactose (+) yogurt culture), or with a starter culture comprising at least one lactose-deficient Streptococcus thermophilus strain, which is capable of metabolizing a non-lactose carbohydrate, and at least one lactose-deficient Lactobacillus strain, preferably at least one lactose-deficient L. delbrueckii subsp. bulgaricus strain, which is capable of metabolizing the non-lactose carbohydrate in the presence of a non-lactose carbohydrate, preferably sucrose, in an amount measured so as to become depleted when the pH of the fermented milk is lower than 4.9, such as 4.55 (e.g., about 0.9% sucrose). In addition, advantageously, the fermented milk product of the present invention will have higher stability of probiotic counts over time, e.g., over at least 60 days shelf life, preferably at about 4° C. (storage at about 4° C.).

Hence, the present invention provides a food or feed product (a fermented milk product) comprising at least one lactose-deficient Streptococcus thermophilus strain, which is capable of metabolizing a non-lactose carbohydrate, and at least one lactose-deficient Lactobacillus strain, preferably at least one lactose-deficient L. delbrueckii subsp. bulgaricus strain, which is capable of metabolizing a non-lactose carbohydrate and a probiotic strain selected from the group consisting of Lactobacillus strain and a Bifidobacterium strain, wherein the food or feed product comprises 1.3E+08 CFU or more of probiotic cells/g of fermented milk product (CFU/g), preferably 2E+08 CFU/g or more, or 3E+08 CFU/g or more, or 4E+08 CFU/g or more, even more preferably 5E+08 CFU/g or more, such as 6E+08 CFU/g or more of at least one probiotic strain present in the food or feed product, immediately after fermentation (i.e., fermentation step (ii) of the present invention), preferably at a time point which is at least 1 day after fermentation has been completed, such as 15 days, or 30 days, or 45 days, or 60 days after fermentation has been completed, wherein the food or feed product has been kept at about 4° C. after fermentation according to step ii. of the process of the present invention has finalized (been completed), preferably wherein the milk base comprises about 2 wt. % fat and about 4.1 wt. % protein, preferably wherein the fermentation took place at about 38° C. preferably until a pH of about 4.55 was reached. The food or feed product of the present invention thus has very high amounts of probiotics (more than 1.3E+08 CFU/g, as described above). Adding such high amounts of probiotics to an already fermented milk product would affect properties such as taste and flavor of the fermented milk product. In addition, it would be very expensive, since it would involve the addition of probiotics in an amount of 30-50 times more than the inoculation rate of the milk base before fermentation according to the present invention. Accordingly, the food or feed product of the present invention also shows these advantages as compared with a food or feed product comprising substantially the same amount of probiotics, but wherein the probiotics have been added after the fermentation of the milk base.

As indicated above, in the context of the process of the present invention, preferably, the at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain which are comprised in the food or feed product (a fermented milk product) of the present invention, are capable of metabolizing the same non-lactose carbohydrate, which is preferably sucrose.

The food or feed product (fermented milk product) of the present invention may comprise any number of further components, including fermented milk, food additives, stabilizers, cryoprotective agents, flavoring agents, artificial sweeteners and the like. The food or feed product of the present invention can be any fermented milk product, including yoghurt, such as fruit yoghurt, yoghurt beverage, stirred yoghurt, set yoghurt, yoghurt-like drink, strained yoghurt, etc. Preferably, the food or feed product of the present invention is yoghurt.

In the context of the present invention in any of its embodiments, the term “yoghurt” refers to products comprising Streptococcus thermophilus and Lactobacillus delbrueckii subsp. bulgaricus and optionally other microorganisms such as Lactobacillus delbrueckii subsp. lactis, Bifidobacterium animalis subsp. lactis, Lactococcus lactis, Lactobacillus acidophilus and Lactobacillus paracasei, or any microorganism derived therefrom. The lactic acid strains other than Streptococcus thermophilus and Lactobacillus delbrueckii subsp. bulgaricus are included to give the finished product various properties, such as the property of promoting the equilibrium of the flora. As used herein, the term “yoghurt” encompasses set yoghurt, stirred yoghurt, drinking yoghurt, Petit Suisse, heat treated yoghurt, strained or Greek style yoghurt characterized by a high protein level and yoghurt-like products. In particular, term “yoghurt” encompasses, but is not limited to, yoghurt as defined according to French and European regulations, e.g. coagulated dairy products obtained by lactic acid fermentation by means of specific thermophilic lactic acid bacteria only (i.e. Lactobacillus delbrueckii subsp. bulgaricus and Streptococcus thermophilus) which are cultured simultaneously and are found to be live in the final product in an amount of at least 10 million CFU (colony-forming unit)/g. Yoghurts may optionally contain added dairy raw materials (e.g. cream) or other ingredients such as sugar or sweetening agents, one or more flavoring(s), fruit, cereals, or nutritional substances, especially vitamins, minerals and fibers, as well as stabilizers and thickeners. In one alternative, the yoghurt meets the specifications for fermented milks and yoghurts of the AFNOR NF 04-600 standard and/or the codex StanA-IIa-1975 standard. In order to satisfy the AFNOR NF 04-600 standard, the product must not have been heated after fermentation and the dairy raw materials must represent a minimum of 70% (m/m) of the finished product.

Fermented milk obtainable with the process of the present invention, comprising 1.3E+08 CFU of probiotic cells/g of fermented milk (CFU/g) or more, preferably 2E+08 CFU/g or more, or 3E+08 CFU/g or more, or 4E+08 CFU/g or more, even more preferably 5E+08 CFU/g or more, such as 6E+08 CFU/g or more of at least one probiotic strain present in the fermented milk as described herein can also be used as a product additive to, e.g., put into other edible food products such as curd cheeses, chocolates, juices, meat products and dried milk powder products for young infants.

The preferred Streptococcus thermophilus lactose-deficient strains have already been defined in the context of the process of the present invention, and equally apply to this embodiment.

Preferably, the lactose-deficient Lactobacillus strain is a lactose-deficient Lactobacillus delbrueckii subsp. bulgaricus strain. The preferred lactose-deficient Lactobacillus delbrueckii subsp. bulgaricus strains have already been defined in the context of the process of the present invention, and equally apply to this embodiment.

The preferred probiotic strains have been already described in the context of the process of the invention, and equally apply to this embodiment. Accordingly, preferably, the probiotic strain present in the food or feed product of the present invention is one or more of the following probiotic strains:
Bifidobacterium animalis subsp. lactis, BB-12® deposited with the DSMZ-Deutsche Sammlung von Mikroorganismen and Zellkulturen GmbH, Mascheroder Weg. 1b, D-38124 Braunschweig, on 2003 Sep. 30 under the accession number DSM 15954; and/or
Lactobacillus rhamnosus strain, LGG® deposited as ATCC53103; and/or
Lactobacillus acidophilus strain, LA-5®, deposited as DSM 13241.

Accordingly, in a preferred embodiment, the food or feed product (fermented milk product) of the present invention comprises 1.3E+08 CFU or more of probiotic bacteria/g of fermented milk product (CFU/g), preferably 2E+08 CFU/g or more, or 3E+08 CFU/g or more, or 4E+08 CFU/g or more, even more preferably 5E+08 CFU/g or more, such as 6E+08 CFU/g or more of at least one of the above probiotic strains, preferably of Bifidobacterium animalis subsp. lactis, BB-12®, DSM 15954, directly after fermentation, preferably at a time point which is at least 1 day after fermentation according to step ii of the present invention has been completed, such as 15 days, or 30 days, or 45 days, or 60 days after fermentation has been completed, wherein the food or feed product has been kept at about 4° C. after fermentation according to step ii. of the process of the present invention has finalized, preferably wherein the milk base comprises about 2 wt. % fat and about 4.1 wt. % protein, preferably wherein the fermentation took place at about 38° C. and preferably until a pH of about 4.55 was reached.

Of note, the food or feed product (fermented milk product) of the present invention comprises 1.3E+08 CFU/g or more, preferably 2E+08 CFU/g or more, or 3E+08 CFU/g or more, or 4E+08 CFU/g or more, even more preferably 5E+08 CFU/g or more, such as 5.7E+08 CFU/g or more of at least one of the probiotic strains present in the product at 60 days after fermentation has been completed (60 days of storage), wherein the food or feed product has been kept at about 4° C. after fermentation according to step ii. of the process of the present invention has finalized, and preferably wherein the milk base has about 2 wt. % fat and about 4.1 wt. % protein, preferably wherein the fermentation took place at about 38° C. and preferably until a pH of about 4.55 was reached. Accordingly, the food or feed product of the present invention (fermented milk product) shows higher stability (the increased amount of viable probiotic bacteria is maintained over time) over 60 days of storage (at about 4° C.) than a food or feed product which has been fermented using the same milk base, in the same fermentation conditions, with the same initial amount of probiotic cells, but with one of the following:
No starter culture, i.e., a milk base incubated only with the probiotic bacteria;
A starter culture comprising at least one Streptococcus thermophilus strain, which is not lactose-deficient (lac+), and at least one Lactobacillus strain which is not lactose-deficient, preferably (lac+) L. delbrueckii subsp. bulgaricus, (e.g., traditional lactose (+) yogurt culture);
A starter culture comprising at least one lactose-deficient (lac-) Streptococcus thermophilus strain, which is capable of metabolizing a non-lactose carbohydrate, and at least one lactose-deficient (lac-) Lactobacillus strain, preferably at least one lactose-deficient L. delbrueckii subsp. bulgaricus strain, which is capable of metabolizing a non-lactose carbohydrate, in the presence of non-lactose carbohydrate(s), preferably sucrose, in an amount measured so as to become depleted when the pH of the fermented milk is lower than 4.9, such as 4.55.

### Composition

The present invention provides a composition (hereinafter “the composition of the invention”) for producing a fermented milk product comprising

a) a starter culture of lactic acid bacteria (LAB) comprising or, alternatively, consisting of, at least one lactose-deficient Streptococcus thermophilus strain, which is capable of metabolizing a non-lactose carbohydrate, and at least one lactose-deficient Lactobacillus strain, preferably L. delbrueckii subsp. bulgaricus strain, which is capable of metabolizing a non-lactose carbohydrate; and

b) one or more non-lactose carbohydrate(s) capable of being metabolized by the lactic acid bacteria as defined in a), wherein the non-lactose carbohydrate(s) is(are) present in the composition in an amount measured so as to become depleted when the pH of the fermented milk product is between 4.9 and 5.5, such as between 5.0 and 5.4, preferably about 5.3.

As indicated above, in the context of the process of the present invention, preferably, the at least one lactose-deficient Streptococcus thermophilus strain, which is capable of metabolizing a non-lactose carbohydrate, and the at least one lactose-deficient Lactobacillus strain, which is capable of metabolizing a non-lactose carbohydrate, preferably a lactose-deficient Lactobacillus delbrueckii subsp. bulgaricus strain, which are comprised in the food or feed product (a fermented milk product) of the present invention, are capable of metabolizing the same non-lactose carbohydrate, which is preferably sucrose. In other embodiments, the at least one lactose-deficient Streptococcus thermophilus strain, which is capable of metabolizing a non-lactose carbohydrate, and at least one lactose-deficient Lactobacillus strain, which is capable of metabolizing a non-lactose carbohydrate, preferably a lactose-deficient Lactobacillus delbrueckii subsp. bulgaricus strain, which are comprised in the starter culture which is added to the milk base in step a of the present invention, are capable of metabolizing different non-lactose carbohydrates, preferably wherein the non-lactose carbohydrate is not glucose. For example, the at least one lactose-deficient Streptococcus thermophilus strain is capable of metabolizing sucrose and the at least one lactose-deficient Lactobacillus strain is capable of metabolizing galactose, or vice versa.

In a particular embodiment, the composition comprises two or more lactose-deficient Streptococcus thermophilus strains and one lactose-deficient Lactobacillus strain, preferably one lactose-deficient L. delbrueckii subsp. bulgaricus strain.

The starter culture of the composition of the present invention has been described in detail previously, when describing the starter culture added in step i.a. of the process of the present invention. Accordingly, the starter culture (a) comprised in the composition of the present invention corresponds to the starter culture added to the milk base in step i.a. of the process of the present invention, which has been described in detail above, and equally applies to the composition of the present invention.

In addition, the non-lactose carbohydrate capable of being metabolized by the lactic acid bacteria of the starter culture, comprised in the composition of the present invention (b) has been described in detail in the context of the process of the present invention (step i.b.).

The preferred Streptococcus thermophilus lactose-deficient strains have already been defined in the context of the process of the present invention, and equally apply to this embodiment.

Preferably, the lactose-deficient Lactobacillus strain is a lactose-deficient Lactobacillus delbrueckii subsp. bulgaricus strain. The preferred lactose-deficient Lactobacillus delbrueckii subsp. bulgaricus strains have already been defined in the context of the process of the present invention, and equally apply to this embodiment.

In a preferred embodiment, the composition of the invention further comprises at least a probiotic strain selected from the group consisting of Lactobacillus strain and a Bifidobacterium strain.

The probiotic strain preferably comprised in the composition of the present invention has been described in detail in the context of the process of the present invention (step i.c.). Accordingly, the probiotic strain selected from the group consisting of Lactobacillus strain and a Bifidobacterium strain, preferably comprised in the composition of the present invention corresponds to the probiotic strain selected from the group consisting of Lactobacillus strain and a Bifidobacterium strain added to the milk base in step i.c. of the process of the present invention, which has been described in detail above, and equally applies to the composition of the present invention.

Accordingly, in a preferred embodiment of the present invention, the composition comprises:
a) At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate;
b) one or more non-lactose carbohydrate(s) capable of being metabolized by the lactic acid bacteria as defined in a), wherein the non-lactose carbohydrate(s) is(are) present in the composition in an amount measured so as to become depleted when the pH of the fermented milk product is between 4.9 and 5.5, such as between 5.0 and 5.4, preferably about 5.3; and
c) Bifidobacterium animalis subsp. lactis, BB-12®, deposited as DSM 15954.

Or the composition comprises:
a) At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate;
b) one or more non-lactose carbohydrate(s) capable of being metabolized by the lactic acid bacteria as defined in a), wherein the non-lactose carbohydrate(s) is(are) present in the composition in an amount measured so as to become depleted when the pH of the fermented milk product is between 4.9 and 5.5, such as between 5.0 and 5.4, preferably about 5.3;
c) Bifidobacterium animalis subsp. lactis, BB-12®, deposited as DSM 15954; and
d) Lactobacillus rhamnosus strain, LGG®, deposited as ATCC 53103.

Or the composition comprises:
a) At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate;
b) one or more non-lactose carbohydrate(s) capable of being metabolized by the lactic acid bacteria as defined in a), wherein the non-lactose carbohydrate(s) is(are) present in the composition in an amount measured so as to become depleted when the pH of the fermented milk product is between 4.9 and 5.5, such as between 5.0 and 5.4, preferably about 5.3;
c) Bifidobacterium animalis subsp. lactis, BB-12®, deposited as DSM 15954; and
d) Lactobacillus acidophilus strain, LA-5®, deposited as DSM 13241.

The amounts of strains present in the starter culture and/or the amounts of probiotic strains(s) have been described above in the context of the process of the present invention, and equally apply to the composition of the present invention.

In a preferred embodiment, the composition of the invention comprises from 1E+04 to 1E+09 CFU of the Streptococcus thermophilus strain/g of composition or more, preferably from 1E+05 to 1E+07 CFU/g, or from 1E+06 to 1E+07 CFU/g of the Streptococcus thermophilus strain. More preferably, the composition of the invention comprises about 6-7E+08 CFU/g or less of the Streptococcus thermophilus strain.

In a preferred embodiment, the composition of the invention comprises from 1E+04 to 1E+09 CFU of the Lactobacillus delbrueckii subsp. bulgaricus strain/g of composition, preferably from 1E+05 to 1E+07 CFU/g, or from 1E+06 to 1E+07 CFU/g of the Lactobacillus delbrueckii subsp. bulgaricus strain. More preferably, the composition of the invention comprises about 1E+07 CFU of the Lactobacillus delbrueckii subsp. bulgaricus strain/g of composition.

In a preferred embodiment, the composition of the invention comprises a total amount of CFU of at least 1E+10 CFU/g (i.e., considering the amount of Streptococcus thermophilus, Lactobacillus delbrueckii subsp. bulgaricus and probiotic strains, if any).

As disclosed in WO 2005/003327, it is beneficial to add certain cryoprotective agents to a starter culture. Thus, the starter culture comprised in the composition of the present invention (a.) may comprise one or more cryoprotective agent(s) selected from the group consisting of inosine-5′-monophosphate (IMP), adenosine-5′-monophosphate (AMP), guanosine-5′-monophosphate (GMP), uranosine-5′-monophosphate (UMP), cytidine-5′-monophosphate (CMP), adenine, guanine, uracil, cytosine, adenosine, guanosine, uridine, cytidine, hypoxanthine, xanthine, hypoxanthine, orotidine, thymidine, inosine and a derivative of any such compounds.

Furthermore, starter cultures may be provided as frozen or dried starter cultures in addition to liquid starter cultures. Thus, the composition of the present invention may be in frozen, freeze-dried or liquid form.

### Use of the Present Invention

The present invention further provides the use of the composition of the present invention for increasing the number of viable probiotic cell counts of at least one of the probiotic strains present in a fermented milk product, as compared to a fermented milk product fermented with a composition comprising
a) a starter culture of lactic acid bacteria comprising at least one Streptococcus thermophilus strain, which is not lactose-deficient, and at least one Lactobacillus strain, preferably L. delbrueckii subsp. bulgaricus, which is not lactose-deficient; or
b) i. a starter culture of lactic acid bacteria comprising at least one lactose-deficient Streptococcus thermophilus strain, which is capable of metabolizing a non-lactose carbohydrate, and at least one lactose-deficient Lactobacillus strain, preferably L. delbrueckii subsp. bulgaricus, which is capable of metabolizing a non-lactose carbohydrate, and
   ii. one or more non-lactose carbohydrate(s) capable of being metabolized by the lactic acid bacteria as defined in i), wherein the non-lactose carbohydrate(s) is(are) present in the composition in an amount measured so as to become depleted when the pH of the fermented milk product is between 4.9 and 5.5, such as between 5.0 and 5.4, preferably about 5.3; or
c) The milk base is incubated with the at least one probiotic bacteria (i.e., in the absence of a “starter culture” as described above).

Accordingly, the composition of the present invention may be used to increase the number of viable cell counts of at least one of the probiotic strains present in a fermented milk product, wherein the food or feed product comprises 1.3E+08 CFU or more of probiotic bacteria/g fermented milk product (CFU/g), preferably 2E+08 CFU/g or more, or 3E+08 CFU/g or more, or 4E+08 CFU/g or more, even more preferably 5E+08 CFU/g or more, such as 6E+08 CFU/g or more of at least one probiotic strain present in the food or feed product, immediately after fermentation, preferably at a time point which is at least 1 day after fermentation according to step ii of the process of the present invention has been completed, such as 15 days, or 30 days, or 45 days, or 60 days after fermentation has been completed, wherein the food or feed product has been kept at about 4° C. after fermentation according to step ii. of the process of the present invention has finalized, preferably wherein the milk base comprises about 2 wt. % fat and about 4.1 wt. % protein, preferably wherein the fermentation took place at about 38° C. and preferably until a pH of about 4.55 was reached.

Preferably, the composition of the present invention is used to increase the number of viable cell counts (increase or improve survival) of at least a probiotic strain selected from:
Bifidobacterium animalis subsp. lactis, BB-12®, deposited with the DSMZ-Deutsche Sammlung von Mikroorganismen and Zellkulturen GmbH, Mascheroder Weg. 1b, D-38124 Braunschweig, on 2003 Sep. 30 under the accession number DSM 15954; and/or
Lactobacillus rhamnosus strain, LGG® deposited as ATCC 53103; and/or
Lactobacillus acidophilus strain, LA-5®, deposited as DSM 13241.

Accordingly, in a preferred embodiment, the composition of the present invention is used to increase the number of viable cell counts (increase or improve survival) of at least one of the above probiotic strains present in a fermented milk product, as described above, wherein the fermented milk product comprises 1.3E+08 CFU or more viable cells of probiotic bacteria/g fermented milk product (CFU/g), preferably 2E+08 CFU/g or more, or 3E+08 CFU/g or more, or 4E+08 CFU/g or more, even more preferably 5E+08 CFU/g or more, such as 6E+08 CFU/g or more of at least one of the above probiotic strains, preferably of Bifidobacterium animalis subsp. lactis, BB-12®, DSM 15954, immediately after fermentation, preferably at a time point which is at least 1 day after fermentation according to step ii of the process of the present invention has been completed, such as 15 days, or 30 days, or 45 days, or 60 days after fermentation has been completed, wherein the food or feed product has been kept at about 4° C. after fermentation according to step ii. of the process of the present invention has finalized, preferably wherein the milk base comprises about 2 wt. % fat and about 4.1 wt. % protein, preferably wherein the fermentation took place at about 38° C. and preferably until a pH of about 4.55 was reached.

Accordingly, the present invention provides a method for increasing the number of viable probiotic cell counts of at least one of the probiotic strains present in a fermented milk product using the composition of the present invention, as described in detail above.

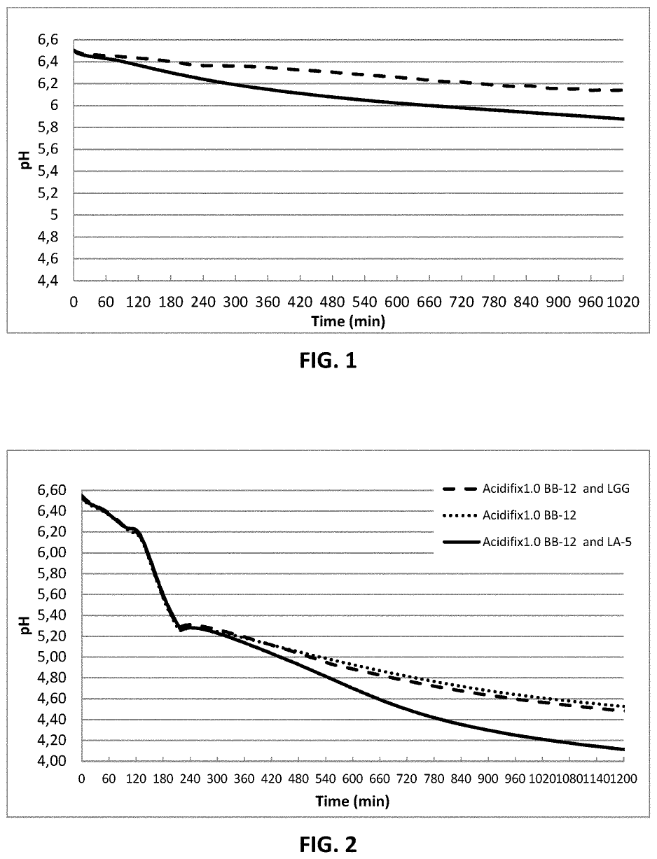

As used herein, the term “for increasing or improving survival of the viable probiotic cells over time” means that the number of viable probiotic cell counts in a product fermented with the starter culture of the present invention is kept higher over time than the number of probiotic cell counts in a product fermented which has been fermented using the same milk base, in the same fermentation conditions, with the same initial amount of probiotic cells, but with one of the following:
No starter culture, i.e., a milk base incubated only with the probiotic bacteria (as shown in FIG. 1, probiotics do not readily grow in milk, or grow very slow);
A starter culture comprising at least one Streptococcus thermophilus strain, which is not lactose-deficient (lac+), and at least one Lactobacillus strain which is not lactose-deficient, preferably (lac+) L. delbrueckii subsp. bulgaricus, (e.g., traditional lactose (+) yogurt culture);
A starter culture comprising at least one lactose-deficient (lac-) Streptococcus thermophilus strain, which is capable of metabolizing a non-lactose carbohydrate, and at least one lactose-deficient (lac-) Lactobacillus strain, preferably at least one lactose-deficient L. delbrueckii subsp. bulgaricus strain, which is capable of metabolizing the non-lactose carbohydrate, in the presence of non-lactose carbohydrate, preferably sucrose, in an amount measured so as to become depleted when the pH of the fermented milk is lower than 4.9, such as 4.55.

In this context, “over time” means over at least 1 day after fermentation according to step ii of the process of the present invention has been completed, such as 15 days, or 30 days, or 45 days, or 60 days after fermentation has been completed, wherein the food or feed product has been kept at about 4° C. after fermentation according to step ii. of the process of the present invention has finalized, preferably wherein the milk base comprises about 2 wt. % fat and about 4.1 wt. % protein.

As used herein, the term “about” (or “around”) means the indicated value±1% of its value, or the term “about” means the indicated value±2% of its value, or the term “about” means the indicated value±5% of its value, the term “about” means the indicated value±10% of its value, or the term “about” means the indicated value±20% of its value, or the term “about” means the indicated value±30% of its value; preferably the term “about” means exactly the indicated value (±0%).

Unless otherwise defined, all technical and scientific terms used herein have the same meaning as commonly understood by one of ordinary skilled in the art to which this invention belongs. Methods and materials similar or equivalent to those described herein can be used in the practice of the present invention. Additional objects, advantages and features of the invention will become apparent to those skilled in the art upon examination of the description or may be learned by practice of the invention. The following examples and drawings are provided by way of illustration, and they are not intended to be limiting of the present invention

Throughout the description and claims the word “comprise” and variations of the word (e.g., “comprising”, “having”, “including”, “containing”) typically is not limiting and thus does not exclude other features, which may be for example technical features, additives, components, or steps. However, whenever the word “comprise” is used herein, this also includes a special embodiment in which this word is understood as limiting; in this particular embodiment the word “comprise” has the meaning of the term “consist of”.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

### Preferred Embodiments

1. A process for producing a fermented milk product comprising the steps of:
i. Adding to a milk base:
   a. a starter culture of lactic acid bacteria comprising at least one lactose-deficient Streptococcus thermophilus strain, which is capable of metabolizing a non-lactose carbohydrate, and at least one lactose-deficient Lactobacillus strain, preferably L. delbrueckii subsp. bulgaricus, which is capable of metabolizing a non-lactose carbohydrate, preferably wherein the starter culture is added in an amount of 1.2-1.3E+07 CFU of Streptococcus thermophilus strain and Lactobacillus strain/ml of milk base, preferably wherein the ratio of the at least one lactose-deficient Streptococcus thermophilus strain (ST) to the at least one lactose-deficient Lactobacillus strain, preferably L. delbrueckii subsp. bulgaricus (LB) in the starter culture is from 1:99 to 99:1 (ST:LB), such as 50:50, more preferably from 90:10 to 99:1 (ST:LB);
   b. one or more non-lactose carbohydrate(s) capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
   c. a probiotic strain selected from the group consisting of Lactobacillus strain and a Bifidobacterium strain;
ii. fermenting the milk base for a period of time until a target pH is reached to obtain a fermented milk product.

2. The process according to item 1, wherein the at least one lactose-deficient Streptococcus thermophilus strain, and the at least one lactose-deficient Lactobacillus strain, preferably L. delbrueckii subsp. bulgaricus, are capable of metabolizing the same non-lactose carbohydrate.

3. The process according to any of items 1-2, wherein the non-lactose carbohydrate(s) is(are) selected from the group consisting of sucrose, galactose and glucose, preferably wherein the non-lactose carbohydrate is not glucose, even more preferably wherein the non-lactose carbohydrate is sucrose.

4. The process according to any of items 1-3, wherein the target pH of step ii. is about 4.8 to about 4.0, preferably about 4.6- to about 4.55, even more preferably about 4.55.

5. The process according to any of items 1-4, wherein the Streptococcus thermophilus lactose-deficient strain is selected from the group consisting of:
(a) (i) the strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28952;
   (ii) a strain derived from DSM 28952, wherein the derived strain is further characterized as having the ability to generate white colonies on a medium containing lactose and X-Gal;
(b) (i) the strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28953;
   (ii) a strain derived from DSM 28953, wherein the derived strain is further characterized as having the ability to generate white colonies on a medium containing lactose and X-Gal;
(c) (i) the strain deposited with DSMZ-Deutsche Sammlung von Mikroorganismen und Zellkulturen GmbH, Inhoffenstr. 7B, D-38124 Braunschweig, on 2017 Aug. 22 under the accession no. DSM 32599;
   (ii) a strain derived from DSM 32599, wherein the derived strain is further characterized as having the ability to generate white colonies on a medium containing lactose and X-Gal; and
(d) (i) the strain deposited with DSMZ-Deutsche Sammlung von Mikroorganismen und Zellkulturen GmbH, Inhoffenstr. 7B, D-38124 Braunschweig, on 2017 Aug. 22 under the accession no. DSM 32600; and
   (ii) a strain derived from DSM 32600, wherein the derived strain is further characterized as having the ability to generate white colonies on a medium containing lactose and X-Gal.

6. The process according to any of items 1-5, wherein the lactose-deficient Lactobacillus strain is a L. delbrueckii subsp. bulgaricus strain is selected from the group consisting of:
(i) the strain deposited with DSMZ-Deutsche Sammlung von Mikroorganismen and Zellkulturen GmbH, Inhoffenstr. 7B, D-38124 Braunschweig, on 2014 Jun. 12 under the accession no. DSM 28910; and
(ii) a strain derived from DSM 28910, wherein the derived strain is further characterized as having the ability to generate white colonies on a medium containing lactose and X-Gal.

7. The process according to any of items 1-6, wherein the probiotic strain is not a Lactobacillus paracasei strain, even more preferably wherein the probiotic Lactobacillus strain is not L. paracasei strain CRL 431, deposited as ATCC 55544 or L. paracasei strain CHCC 2115, deposited as DSM 19465.

8. The process according to any of items 1-7, wherein the probiotic Lactobacillus strain is selected from the group consisting of a Lactobacillus rhamnosus strain, a Lactobacillus paracasei strain and a Lactobacillus acidophilus strain and/or wherein the probiotic Bifidobacterium strain is selected from the group consisting of Bifidobacterium longum, Bifidobacterium adolescentis, Bifidobacterium bifidum, Bifidobacterium breve, Bifidobacterium animalis subsp. lactis and Bifidobacterium infantis.

9. The process according to any of items 1-8, wherein the probiotic strain is selected from the group consisting of Lactobacillus rhamnosus strain, LGG®, deposited as ATCC 53103, Lactobacillus paracasei strain CRL 431, deposited as ATCC 55544, Lactobacillus acidophilus strain, LA-5®, deposited as DSM 13241 and Bifidobacterium animalis subsp. lactis, BB-12®, deposited as DSM 15954.

10. The process according to any one of items 1-9, wherein the probiotic strain added to the milk base in step i.c. comprises a Bifidobacterium strain, preferably a probiotic Bifidobacterium strain selected from the group consisting of Bifidobacterium longum, Bifidobacterium adolescentis, Bifidobacterium bifidum, Bifidobacterium breve, Bifidobacterium animalis subsp. lactis and Bifidobacterium infantis, even more preferably Bifidobacterium animalis subsp. lactis, BB-12®, deposited as DSM 15954.

11. The process according to any of items 1-10, wherein step i. comprises adding to a milk base:
a. At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate, preferably wherein the at least one lactose-deficient Streptococcus thermophilus strain, which is capable of metabolizing a non-lactose carbohydrate, and the at least one lactose-deficient Lactobacillus delbrueckii subsp. bulgaricus strain, which is capable of metabolizing a non-lactose carbohydrate are added in an amount of 1.2-1.3E+07 CFU;
b. One or more non-lactose carbohydrate(s) capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
c. Bifidobacterium animalis subsp. lactis, BB-12®, deposited as DSM 15954, preferably in an amount of about 1.2E+07 CFU/ml milk base.

12. The process according to any of items 1-10, wherein step i. comprises adding to a milk base:
a. At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate, preferably wherein the at least one lactose-deficient Streptococcus thermophilus strain, which is capable of metabolizing a non-lactose carbohydrate, and the at least one lactose-deficient Lactobacillus delbrueckii subsp. bulgaricus strain, which is capable of metabolizing a non-lactose carbohydrate are added in an amount of 1.2-1.3E+07 CFU;
b. One or more non-lactose carbohydrate(s) capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
c. Bifidobacterium animalis subsp. lactis, BB-12®, deposited as DSM 15954 and Lactobacillus rhamnosus strain, LGG®, deposited as ATCC 53103, preferably wherein Bifidobacterium animalis subsp. lactis, BB-12®, is added in an amount of about 1.2E+07 CFU/ml and Lactobacillus rhamnosus strain, LGG®, is added in an amount of about 7E+06 CFU/ml.

13. The process according to any of items 1-10, wherein step i. comprises adding to a milk base:
a. At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate, preferably wherein the at least one lactose-deficient Streptococcus thermophilus strain, which is capable of metabolizing a non-lactose carbohydrate, and the at least one lactose-deficient Lactobacillus delbrueckii subsp. bulgaricus strain, which is capable of metabolizing a non-lactose carbohydrate are added in an amount of 1.2-1.3E+07 CFU;
b. One or more non-lactose carbohydrate(s) capable of being metabolized by the lactic acid bacteria as defined in a., wherein the non-lactose carbohydrate(s) is(are) added in an amount measured so as to become depleted when the pH of the fermented milk product is between 4.9 and 5.5, such as between 5.0 and 5.4, preferably about 5.3; and
c. Bifidobacterium animalis subsp. lactis, BB-12®, deposited as DSM 15954 and Lactobacillus acidophilus strain, LA-5®, deposited as DSM 13241, preferably wherein Bifidobacterium animalis subsp. lactis, BB-12®, is added in an amount of about 1.2E+07 CFU/ml and Lactobacillus acidophilus strain, LA-5®, is added in an amount of about 7E+06 CFU/ml.

14. The process according to any of items 11-13, wherein the at least one lactose-deficient Streptococcus thermophilus strain, which is capable of metabolizing a non-lactose carbohydrate is defined as in item 5, and wherein the at least one lactose-deficient Lactobacillus delbrueckii subsp. bulgaricus strain, which is capable of metabolizing the non-lactose carbohydrate is defined as in item 6.

15. The process according to any of items 1-14, wherein from 1E+04 to 1E+10 CFU (colony forming units)/ml of milk base of the Streptococcus thermophilus strain, preferably from 1E+05 to 1E+10 CFU/ml, or from 1E+06 to 1E+10 CFU/ml, or from 1E+07 to 1E+09 CFU/ml, preferably from about 1E+06 to about 1E+08 CFU/ml of the Streptococcus thermophilus strain are added to the milk base in step i.a.

16. The process according to any of items 1-15, wherein from 1E+04 to 1E+10 CFU/ml of milk base of the Lactobacillus delbrueckii subsp. bulgaricus strain, preferably from 1E+05 to 1E+10 CFU/ml, or from 1E+06 to 1E+10 CFU/ml, or from 1E+07 to 1E+09 CFU/ml, preferably from about 1E+06 to about 1E+08 CFU/ml of the Lactobacillus delbrueckii subsp. bulgaricus strain are added to the milk base in step i.a.

17. The process according to any of items 1-16, wherein from about 1E+06 to about 1E+08 CFU/ml of milk base of the probiotic strain, preferably from about 5E+06 to about 5E+07 CFU/ml, more preferably from about 1 to 1.5E+07 CFU/ml, such as about 1.2E+07 CFU/ml, or wherein about 7E+06 CFU/ml of the probiotic strain are added to the milk base in step i.c.

18. The process according to any of items 1-17, wherein the non-lactose carbohydrate, preferably sucrose, is added to the milk base in step i.b. in an amount of less than 0.9%, preferably in an amount of less than 0.7%, even more preferably in an amount of less than 0.5%, such as 0.41%, wherein % is weight per volume (% w/v) of milk base.

19. A fermented milk product produced by the process of items 1-18.

20. A food or feed product comprising at least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate and a probiotic strain selected from the group consisting of Lactobacillus strain and a Bifidobacterium strain, preferably wherein the Lactobacillus strain is not a Lactobacillus paracasei strain, even more preferably wherein the Lactobacillus strain is not L. paracasei strain CRL 431, deposited as ATCC 55544 or L. paracasei strain CHCC 2115, deposited as DSM 19465, wherein the food or feed product comprises 1.3E+08 CFU viable cells of probiotic bacteria/g of fermented milk product (CFU/g) or more, preferably 2E+08 CFU/g or more, even more preferably 5E+08 CFU/g or more, such as 6E+08 CFU/g of at least one of the probiotic strains present in the food or feed product, immediately after fermentation, preferably at a time point which is at least 1 day after fermentation has been completed, such as 15 days, or 30 days, or 45 days, or 60 days after fermentation has been completed, wherein the food or feed product has been kept at about 4° C. after fermentation has been completed.

21. The food or feed product according to item 20, wherein the probiotic Lactobacillus strain is selected from the group consisting of a Lactobacillus rhamnosus strain, a Lactobacillus paracasei strain and a Lactobacillus acidophilus strain and wherein the probiotic Bifidobacterium strain is selected from the group consisting of Bifidobacterium longum, Bifidobacterium adolescentis, Bifidobacterium bifidum, Bifidobacterium breve, Bifidobacterium animalis subsp. lactis and Bifidobacterium infantis.

22. The food or feed product according to any of items 20-21, wherein the food or feed product is a fermented milk product, preferably a fermented milk beverage, more preferably yoghurt.

23. The food or feed product according to any of items 20-22, wherein the Streptococcus thermophilus lactose-deficient strain is a strain as defined in item 5; and/or wherein the lactose-deficient Lactobacillus delbrueckii subsp. bulgaricus strain is a strain as defined in item 6; and/or wherein the probiotic Lactobacillus strain is selected from the group consisting of Lactobacillus rhamnosus strain, LGG®, deposited as ATCC 53103, Lactobacillus paracasei strain CRL 431, deposited as ATCC 55544, Lactobacillus acidophilus strain, LA-5®, s deposited as DSM 13241 and Bifidobacterium animalis subsp. lactis, BB-12®, deposited as DSM 15954.

24. A composition for producing a fermented milk product comprising
a) a starter culture of lactic acid bacteria comprising at least one lactose-deficient Streptococcus thermophilus strain, which is capable of metabolizing a non-lactose carbohydrate, and at least one lactose-deficient Lactobacillus strain, preferably L. delbrueckii subsp. bulgaricus, which is capable of metabolizing a non-lactose carbohydrate; and
b) one or more non-lactose carbohydrate(s) capable of being metabolized by the lactic acid bacteria as defined in a), wherein the non-lactose carbohydrate(s) is(are) present in the composition in an amount measured so as to become depleted when the pH of the fermented milk product is between 4.9 and 5.5, such as between 5.0 and 5.4, preferably about 5.3.

25. The composition according to item 24, wherein the at least one lactose-deficient Streptococcus thermophilus strain, and the at least one lactose-deficient Lactobacillus strain, preferably L. delbrueckii subsp. bulgaricus, are capable of metabolizing the same non-lactose carbohydrate.

26. The composition according to any of items 24-25, wherein the non-lactose carbohydrate is selected from the group consisting of sucrose, galactose and glucose, preferably wherein the non-lactose carbohydrate is not glucose, even more preferably wherein the non-lactose carbohydrate is sucrose.

27. The composition according to any of items 24-26, wherein the Streptococcus thermophilus lactose-deficient strain is a strain as defined in item 5; and/or wherein the lactose-deficient Lactobacillus strain is a L. delbrueckii subsp. bulgaricus strain as defined in item 6.

28. The composition according to any of items 24-27, wherein the composition further comprises a probiotic strain selected from the group consisting of Lactobacillus strain and a Bifidobacterium strain, preferably wherein the Lactobacillus strain is not a Lactobacillus paracasei strain, even more preferably wherein the Lactobacillus strain is not L. paracasei strain CRL 431, deposited as ATCC 55544 or L. paracasei strain CHCC 2115, deposited as DSM 19465.

29. The composition according to any of items 24-28, wherein the probiotic Lactobacillus strain is selected from the group consisting of a Lactobacillus rhamnosus strain, a Lactobacillus paracasei strain and a Lactobacillus acidophilus strain and wherein the probiotic Bifidobacterium strain is selected from the group consisting of Bifidobacterium longum, Bifidobacterium adolescentis, Bifidobacterium bifidum, Bifidobacterium breve, Bifidobacterium animalis subsp. lactis and Bifidobacterium infantis.

30. The composition according to any of items 28-29, wherein the probiotic Lactobacillus strain is selected from the group consisting of Lactobacillus rhamnosus strain, LGG®, deposited as ATCC 53103, Lactobacillus paracasei strain CRL 431, deposited as ATCC 55544, Lactobacillus acidophilus strain, LA-5®, deposited as DSM 13241 and Bifidobacterium animalis subsp. lactis, BB-12®, deposited as DSM 15954.

31. The composition according to any of items 28-30, wherein the composition comprises:
a) At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate; and
b) Bifidobacterium animalis subsp. lactis, BB-12®, deposited as DSM 15954.

32. The composition according to any of items 28-30, wherein the composition comprises:
a) At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate;
b) Bifidobacterium animalis subsp. lactis, BB-12®, deposited as DSM 15954; and
c) Lactobacillus rhamnosus strain, LGG®, deposited as ATCC 53103.

33. The composition according to any of items 28-30, wherein the composition comprises:
a) At least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate;
b) Bifidobacterium animalis subsp. lactis, BB-12®, deposited as DSM 15954; and
c) Lactobacillus acidophilus strain, LA-5®, deposited as DSM 13241.

34. The composition according to any of items 31-33, wherein the at least one lactose-deficient Streptococcus thermophilus strain, which is capable of metabolizing a non-lactose carbohydrate is defined as in item 5, and wherein the at least one lactose-deficient Lactobacillus delbrueckii subsp. bulgaricus strain, which is capable of metabolizing the non-lactose carbohydrate is defined as in item 6.

35. The composition according to any of items 24-34, wherein the composition comprises from about 6-7E+08 CFU (colony forming units)/g of the Streptococcus thermophilus strain or less.

36. The composition according to any of items 24-35, wherein the composition comprises about 1E+07 CFU/g of the Lactobacillus delbrueckii subsp. bulgaricus strain.

37. The composition according to any of items 24-36, wherein the composition comprises from 1E+06 to 1E+08 CFU/g of the probiotic strain, preferably from 5E+06 to 5E+07 CFU/g, more preferably about 1.2E+07 CFU/g of the probiotic strain.

38. The composition according to any of items 24-37, wherein the non-lactose carbohydrate is present in the composition in an amount of less than 0.9%, preferably in an amount of less than 0.7%, even more preferably in an amount of less than 0.5%, such as about 0.41%, wherein % is weight per volume (% w/v) of milk base.

39. Use of the composition as defined in any of items 24-38 for increasing the number of probiotic cell counts in a fermented milk product, as compared to a fermented milk product fermented with a composition comprising
a) a starter culture of lactic acid bacteria comprising at least one Streptococcus thermophilus strain, which is not lactose-deficient, and at least one Lactobacillus delbrueckii subsp. bulgaricus strain, which is not lactose-deficient; and/or
b) i. a starter culture of lactic acid bacteria comprising at least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing a non-lactose carbohydrate, and
   ii. one or more non-lactose carbohydrate(s) capable of being metabolized by the lactic acid bacteria as defined in i), wherein the non-lactose carbohydrate(s) is(are) present in the composition in an amount measured so as to become depleted when the pH of the fermented milk product is below 4.9,
      preferably wherein the fermented milk product comprises at least 2E+08 CFU viable probiotic cells/g fermented milk product, preferably at least 4E+08 CFU viable probiotic cells/g fermented milk product, even more preferably at least 5.5E+08 CFU, such as 5.7E+08 CFU viable probiotic cells/g fermented milk product after 60 days of shelf life (storage) at 4° C.

### Deposits and Expert Solution

The Applicant requests that the availability of the deposited microorganism referred to in Rule 33 EPC shall be effected only by the issue of a sample to an independent expert nominated by the requester (Rule 32(1) EPC).

Streptococcus thermophilus strain deposited with DSMZ-Deutsche Sammlung von Mikroorganismen and Zellkulturen GmbH, Inhoffenstr. 7B, D-38124 Braunschweig, on 2014 Jun. 12 under the accession no. DSM 28952.

Streptococcus thermophilus strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28953.

Streptococcus thermophilus strain deposited with DSMZ-Deutsche Sammlung von Mikroorganismen und Zellkulturen GmbH, Inhoffenstr. 7B, D-38124 Braunschweig, on 2017 Aug. 22 under the accession no. DSM 32599.

Streptococcus thermophilus strain deposited with DSMZ-Deutsche Sammlung von Mikroorganismen und Zellkulturen GmbH, Inhoffenstr. 7B, D-38124 Braunschweig, on 2017 Aug. 22 under the accession no. DSM 32600.

Lactobacillus delbrueckii subsp. bulgaricus strain deposited with DSMZ-Deutsche Sammlung von Mikroorganismen und Zellkulturen GmbH, Inhoffenstr. 7B, D-38124 Braunschweig, on 2014 Jun. 12 under the accession no. DSM 28910;

Bifidobacterium animalis subsp. lactis strain, BB-12®, deposited with DSMZ-Deutsche Sammlung von Mikroorganismen und Zellkulturen GmbH, Mascheroder Weg. 1b, D-38124 Braunschweig, on 2003 Sep. 30 under the accession no. DSM 15954;

Lactobacillus acidophilus strain, LA-5®, deposited with DSMZ-Deutsche Sammlung von Mikroorganismen und Zellkulturen GmbH, Mascheroder Weg. 1b, D-38124 Braunschweig, on 2003 Sep. 30 under the accession no. DSM 13241.

The deposits were made by the applicant CHR. HANSEN A/S according to the Budapest treaty on the international recognition of the deposit of microorganisms for the purposes of patent procedure.

### Trademarks

BB-12® is a registered trademark of Chr. Hansen.

LGG® is a is a registered trademark of Chr. Hansen.

LA-5® is a registered trademark of Chr. Hansen.

YoFlex® is a registered trademark of Chr. Hansen.

Acidifix® is a registered trademark of Chr. Hansen.

### EXAMPLES

### Example 1

The object of this example is to compare the effect of a starter culture of lactic acid bacteria in the cell counts of the probiotic cultures BB-12®, LGG® and/or LA-5®, wherein the starter culture comprises at least one lactose-deficient Streptococcus thermophilus strain, which is capable of metabolizing a non-lactose carbohydrate, and at least one lactose-deficient Lactobacillus delbrueckii subsp. bulgaricus strain, which is capable of metabolizing the non-lactose carbohydrate and a non-lactose carbohydrate capable of being metabolized by the lactic acid bacteria of the starter culture as defined above, wherein the non-lactose carbohydrate is present in the composition in an amount measured so as to become depleted when the pH of the fermented milk product is around 5.3.

### Starter Cultures

Acidifix®: Lactose-deficient culture containing at least one lactose-deficient Streptococcus thermophilus (ST) strains and at least one lactose-deficient Lactobacillus delbrueckii subsp. bulgaricus (LB) strains, which is commercially available as “F-DVS YoFlex® Acidifix® 1.0”, from Chr. Hansen A/S. The strains were isolated as described, e.g., in Example 1 of EP 2957180.

YoFlex® Mild 1.0: Commercial, lactose-positive yogurt culture comprising lactose-positive Streptococcus thermophilus strains and lactose-positive Lactobacillus delbrueckii subsp. bulgaricus strains. Commercial strain F-DSV (Frozen Direct Vat Set (DVS), concentrated frozen culture) YoFlex® Mild 1.0 from Chr. Hansen A/S. F-DVS YoFlex® Mild 1.0 is commercially available from Chr. Hansen A/S, GIN 702897.

### Probiotic Cultures

LGG®: Lactobacillus rhamnosus strain, LGG®, deposited as ATCC 53103.

BB-12®: Bifidobacterium animalis subsp. lactis strain, BB-12®, deposited as DSM 15954.

LA-5®: Lactobacillus acidophilus, LA-5® deposited as DSM 13241.

### Culture Compositions

The above probiotics strains were used to perform the test: Bifidobacterium animalis ssp. Lactis, BB-12®, Lactobacillus acidophilus, LA-5®, and Lactobacillus rhamnosus, LGG®. They were combined with F-DVS YoFlex® Acidifix® 1.0 which is composed of Lac(−) ST and Lac (−) LB strains, as indicated above. Lactose (+) yogurt culture F-DSV YoFlex® Mild 1.0, as described above, +BB-12® and single F-DVS BB-12® with no yogurt culture, were used as controls.

Inoculation matrix (“culture combination”) is shown in Table 1 below.

TABLE 1
Inoculation matrix. The inoculation % refers to weight per volume (w/v) of the total
amount of milk base. The % amount of sucrose is given as (w/v) based on milk base.

| | | F-DVS | | | | | |
|---|---|---|---|---|---|---|---|
| | | Acidifix ® | F-DVS YF | F-DVS | F-DVS | FD-DVS | |
| | Milk base | 1.0 | Mild 1.0 | BB-12 ® | LA-5 ® | LGG ® | note |
| A | Milk + 0.41% sucrose | 0.01% | | 0.01% | | 0.001% | |
| B | Milk + 0.41% sucrose | 0.01% | | 0.01% | | | |
| C | Milk + 0.41% sucrose | 0.01% | | 0.01% | 0.01% | | |
| D | Milk + 0.90% sucrose | 0.01% | | 0.01% | | | |
| E | Milk + 0.41% sucrose | | 0.01% | 0.01% | | | control |
| F | Milk + 0.41% sucrose | | | 0.02% | | | control |

When F-DVS Acidifix® 1.0 (F-DVS YoFlex® Acidifix® 1.0) or F-DVS YF Mild 1.0 (F-DVS YoFlex® Mild 1.0) are inoculated at 0.01%, cell count of ST and LB upon inoculation (before fermentation) was 1.2-1.3E+07 CFU/ml. Cell count of BB-12® upon inoculation at 0.01% of F-DVS was 1.2E+07 CFU/ml. Cell count of LA-5® upon inoculation at 0.01% of F-DVS was 7E+06 CFU/ml. Cell count of LGG® upon inoculation at 0.001% (of the FD-DVS) was 7E+06 CFU/ml.

Cultures were tested in milk with 2 wt. % fat and added skim milk powder to standardize to 4.1 wt. % protein (milk base). Sucrose was added at 0.41% or 0.90% (wherein % is (w/v) based on milk base) to allow acidification to around pH 5.3 and 4.55, respectively. Milk base was heat treated at 92° C. for 3 min, cooled to 38° C. and inoculated as described. Milk was incubated at 38° C. Acidification profile was followed by on-line pH measurement equipment (CINAC) for 20-24 h.

Fermentation was stopped at pH 4.55, probiotic yogurts were cooled to 4° C. and kept at 4° C. during shelf life (storage). Cell counts were determined by plate count at day 1, 15, 30, 45 and 60.

Theoretically, the highest cell count is achieved by cultivation of a single strain. However, probiotic strains are selected based on ability to survive in human gastrointestinal tract, ability to adhere to intestinal mucosa, and specific beneficial effect on health. They have different metabolic activity than lactic acid bacteria which are used for acidification of milk and production of yogurt and other fermented dairy products. Because it is not their primary function, probiotic strains such as, e.g., BB-12® and LGG®, are not well adapted for growth in milk, thus not able to efficiently acidify it. They are not able to grow and acidify milk below pH 6.1 and 5.8 respectively, in 24 h, see FIG. 1.

Significantly higher probiotic cell count is achieved with a combination of probiotics with F-DVS YoFlex® Acidifix® 1.0, i.e., Lac(−) ST and LB strains, see FIG. 2. The culture combinations were inoculated in milk supplemented with just enough sucrose to enable acidification to around pH 5.30.

As shown in FIG. 2, there are two phases of acidification. The first phase corresponds to an acidification to pH of around 5.30. This is due to the growth of the Lac(−) ST and LB strains (F-DVS YoFlex® Acidifix® 1.0). The second acidification phase from 5.30 to 4.55, or lower, is due only to growth of the probiotics strains, e.g., Bifidobacterium, BB-12®, with or without LA-5® or LGG®. These probiotic strains are able to metabolize the lactose present in the milk and continue the fermentation (acidification) until a desired pH of, e.g., 4.55 is achieved. At this point, the milk is cooled down to stop further acidification.

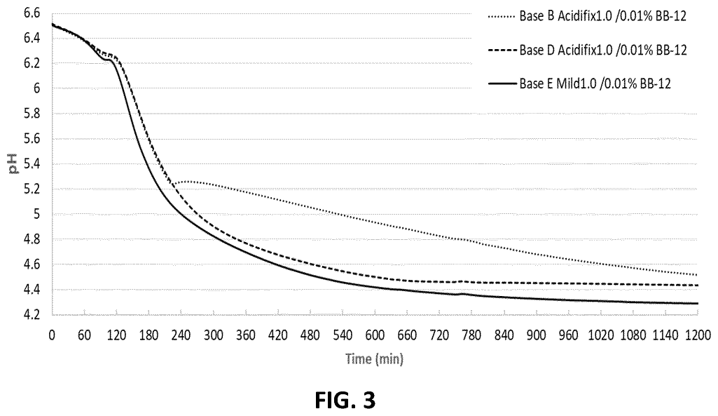

Table 2 shows the time required by each of the cultures tested to reach a pH of 4.55. FIG. 3 shows the acidification profiles of Acidifix® 1.0+0.01% BB-12® in milk with 0.41% (B) and 0.90% sucrose (D). The % amount of sucrose is given as (w/v) based on milk base, as described above.

TABLE 2
Time to pH 4.55

| | Culture combination | minutes | hours |
|---|---|---|---|
| A | Acidifix ® 1.0 (sucrose added to acidify | 1000 | 16.7 |
| | to pH 5.30) + BB-12 ® + LGG ® | | |
| B | Acidifix ® 1.0 (sucrose added to acidify | 1138 | 19 |
| | to pH 5.30) + BB-12 ® | | |
| C | Acidifix ® 1.0 (sucrose added to acidify | 668 | 11.1 |
| | to pH 5.30) + BB-12 ® + LA-5 ® | | |
| D | Acidifix ® 1.0 (sucrose added to acidify | 528 | 8.8 |
| | to pH 4.55) + BB-12 ® | | |
| E | Mild 1.0 (Lac (+) yogurt culture) + BB-12 ® | 450 | 7.5 |
| F | BB-12 ® | n/a | n/a |

The combination of F-DVS YoFlex® Acidifix® 1.0 (i.e., lactose-deficient Streptococcus thermophilus (ST) strains and lactose-deficient Lactobacillus delbrueckii subsp. bulgaricus (LB) strain) that was designed to stop acidifying at pH around 5.30 with probiotics resulted in higher probiotic cell counts, e.g. 1.4-9.6E+08 CFU viable cells of probiotic bacteria/g fermented milk product (CFU/g) of Bifidobacterium, BB-12®, 2.4-4.6E+08 CFU/g of L. acidophilus, LA-5®, and 2.7-4.3E+08 CFU/g of L rhamnosus, LGG®. Cell counts of all probiotics were higher than what typically seen in probiotic fermented milk, and the counts were more stable over 60 days shelf life.

When fermented with Acidifix® 1.0 in milk with limited sucrose levels (0.41%, i.e., designed to stop acidifying at pH around 5.30) (Culture combination A, B and C), cell count of BB-12® was almost 1 log higher than what is typically achieved in combination of with a yogurt culture (lac+), see Table 3 below.

TABLE 3
Cell counts (CFU/g fermented milk product) over 60 days shelf
life, determined by selective enumeration on agar plates.

| A | Acidifix ® 1.0 + BB-12 ® + LGG ® | D1 | D15 | D30 | D45 | D60 |
|---|---|---|---|---|---|---|
| | Bifidobacterium lactis, BB-12 ® | 6.00E+08 | 8.90E+08 | 9.60E+08 | 6.1E+08 | 5.70E+08 |
| | L. rhamnosus, LGG ® | 4.30E+08 | 3.10E+08 | 2.80E+08 | 2.7EE+08 | 2.80E+08 |
| B | Acidifix ® 1.0 + BB-12 ® | | | | | |
| | Bifidobacterium lactis, BB-12 ® | 5.20E+08 | 4.30E+08 | 3.80E+08 | 3.60E+08 | 4.40E+08 |
| C | Acidifix ® 1.0 + BB-12 ® + LA-5 ® | | | | | |
| | Bifidobacterium lactis, BB-12 ® | 2.20E+08 | 2.10E+08 | 1.40E+08 | 2.20E+08 | 2.20E+08 |
| | L. acidophilus, LA-5 ® | 2.70E+08 | 2.40E+08 | 4.60E+08 | 2.80E+08 | 3.10E+08 |
| D | Acidifix ® 1.0 + BB-12 ® pH 4.55 | | | | | |
| | Bifidobacterium lactis, BB-12 ® | 1.30E+08 | 9.90E+07 | 9.20E+07 | 1.10E+08 | 7.40E+07 |
| E | Mild 1.0 + BB-12 ® | | | | | |
| | Bifidobacterium lactis, BB-12 ® | 1.20E+08 | 9.20E+07 | 8.90E+07 | 7.10E+07 | 6.60E+07 |
| F | BB-12 ® | | | | | |
| | Bifidobacterium lactis, BB-12 ® | 1.20E+07 | | | | |

When milk base is supplemented with 0.9% sucrose, which is calculated to allow acidification to pH 4.55 (variable D), Acidifix® 1.0+BB-12® performed in a similar manner as Lactose (+) yogurt culture YoFlex® Mild 1.0+BB-12® (variable E). Cell count of BB-12® in both variables in which lactose-deficient Streptococcus thermophilus (ST) and lactose-deficient Lactobacillus delbrueckii subsp. bulgaricus (LB) were let to acidify to 4.55 were comparable and ranged around 1.2-1.3E+08 CFU/g. Cell count of BB-12® when inoculated without a yogurt culture (variable F), did not increase, it was around 1.2 E+07 CFU/g, which essentially corresponds to the cell count in the inoculum.

### Improved Survival During Shelf Life

Cell counts over 60 days, which is typical shelf life of fresh fermented dairy products in North America and some other regions in the world, was also tested. Over shelf life, in a typical probiotic yogurt, cell count of Bifidobacterium, BB-12® is usually reduced from 0.5-1 log over 60 days, depending on the yogurt culture, milk base, cultivation and storage conditions. Cell counts of LA-5® are typically reduced from 1-2 logs over 60 days shelf life. When co-cultivated with Acidifix® 1.0 (growth limited to pH around 5.30), cell counts of probiotics BB-12®, LA-5® and LGG® were 0.5-1 log higher than typically seen and also showed excellent stability over shelf life (60 days).

1-18. (canceled)

19. A process for producing a fermented milk product, comprising:
(a) adding to a milk base:
(i) a lactic acid bacteria starter culture comprising a lactose-deficient lactic acid bacteria strain capable of metabolizing a non-lactose carbohydrate, wherein the lactose-deficient strain comprises one or more selected from lactose-deficient Streptococcus thermophilus strains and lactose-deficient Lactobacillus strains;
(ii) non-lactose carbohydrate(s) capable of being metabolized by the lactose-deficient strain(s), wherein the non-lactose carbohydrate(s) is(are) added in an amount that will be depleted when the fermented milk product reaches a target pH that is from 4.9 to 5.5; and
(iii) one or more probiotic strains selected from probiotic Lactobacillus strains and probiotic Bifidobacterium strains; and
(b) fermenting the milk base for a period of time until the target pH is reached.

20. The process of claim 19, wherein the lactose-deficient strain comprises a lactose-deficient Streptococcus thermophilus strain and a lactose-deficient L. delbrueckii subsp. bulgaricus strain.

21. The process of claim 19, wherein the non-lactose carbohydrate(s) is(are) selected from sucrose, galactose and glucose.

22. The process of claim 19, wherein the target pH is from about 4.8 to about 4.0.

23. The process of claim 19, wherein the lactose-deficient strain comprises one or more lactose-deficient Streptococcus thermophilus strains selected from:
(a) the strain deposited with Deutsche Sammlung von Mikroorganismen and Zellkulturen GmbH, (Braunschweig, Germany) (DSMZ) under accession number DSM 28952;
(b) a strain derived from DSM 28952, wherein the derived strain is able to generate white colonies on a medium containing lactose and X-Gal;
(c) the strain deposited with DSMZ under accession number DSM 28953;
(d) a strain derived from DSM 28953, wherein the derived strain is able to generate white colonies on a medium containing lactose and X-Gal;
(e) the strain deposited with DSMZ under accession number DSM 32599;
(f) a strain derived from DSM 32599, wherein the derived strain is able to generate white colonies on a medium containing lactose and X-Gal;
(g) the strain deposited with DSMZ under accession number DSM 32600; and
(h) a strain derived from DSM 32600, wherein the derived strain is able to generate white colonies on a medium containing lactose and X-Gal.

24. The process of claim 19, wherein the lactose-deficient strain comprises one or more lactose-deficient Lactobacillus strains selected from:
(a) the strain deposited with DSMZ under accession number DSM 28910; and
(b) a strain derived from DSM 28910, wherein the derived strain is able to generate white colonies on a medium containing lactose and X-Gal.

25. The process of claim 23, wherein the lactose-deficient strain further comprises one or more lactose-deficient Lactobacillus strains selected from:
(a) the strain deposited with DSMZ under accession number DSM 28910; and
(b) a strain derived from DSM 28910, wherein the derived strain is able to generate white colonies on a medium containing lactose and X-Gal.

26. The process of claim 19, wherein the probiotic strain comprises one or more selected from a Lactobacillus rhamnosus strain, a Lactobacillus paracasei strain, a Lactobacillus acidophilus strain, a Bifidobacterium longum strain, a Bifidobacterium adolescentis strain, a Bifidobacterium bifidum strain, a Bifidobacterium breve strain, a Bifidobacterium animalis subsp. lactis strain, and a Bifidobacterium infantis strain.

27. The process of claim 19, wherein the probiotic strain comprises one or more selected from Lactobacillus rhamnosus strain LGG® deposited at the ATCC as ATCC 53103, Lactobacillus paracasei strain L. casei 431® deposited at the ATCC as ATCC 55544, Lactobacillus acidophilus strain LA-5® deposited at DSMZ under accession number DSM 13241, and Bifidobacterium animalis subsp. lactis strain BB-12® deposited at the DSMZ under accession number DSM 15954.

28. The process of claim 19, wherein the probiotic strain comprises one or more selected from a Bifidobacterium longum strain, a Bifidobacterium adolescentis strain, a Bifidobacterium bifidum strain, a Bifidobacterium breve strain, a Bifidobacterium animalis subsp. lactis strain, and a Bifidobacterium infantis strain.

29. The process of claim 19, wherein:
the lactose-deficient strain comprises a lactose-deficient Streptococcus thermophilus strain and a lactose-deficient Lactobacillus delbrueckii subsp. bulgaricus strain; and
the one or more probiotic strains are selected from:
(i) Bifidobacterium animalis subsp. lactis strain BB-12® deposited at DSMZ under accession number DSM 15954;
(ii) Bifidobacterium animalis subsp. lactis strain BB-12® deposited at DSMZ under accession number DSM 15954 and Lactobacillus rhamnosus strain, LGG® deposited at the ATCC as ATCC 53103; and
(iii) Bifidobacterium animalis subsp. lactis strain BB-12® deposited at DSMZ under accession number DSM 15954 and Lactobacillus acidophilus strain LA-5® deposited at DSMZ under accession number DSM 13241.

30. A fermented milk product produced by the process of claim 19.

31. The fermented milk product of claim 30, wherein the product is a food or feed product comprising:
the lactose-deficient strain, wherein the lactose-deficient strain comprises a lactose-deficient Streptococcus thermophilus strain and a lactose-deficient Lactobacillus delbrueckii subsp. bulgaricus strain, and
the one or more probiotic strains,
wherein the food or feed product comprises at least 1.3E+08 CFU viable cells of the probiotic strain(s) per gram of product (CFU/g), when measured at least 1 day after the fermentation of step (b) has been completed, wherein the food or feed product has been kept at about 4° C. from after the fermentation of step (b) has been completed until the measurement.

32. The food or feed product of claim 31, wherein the food or feed product is a yoghurt.

33. The food of feed product of claim 30, wherein one or more of:
(i) the lactose-deficient strain comprises one or more lactose-deficient Streptococcus thermophilus strains selected from:
(a) the strain deposited with Deutsche Sammlung von Mikroorganismen and Zellkulturen GmbH, (Braunschweig, Germany) (DSMZ) under accession number DSM 28952;
(b) a strain derived from DSM 28952, wherein the derived strain is able to generate white colonies on a medium containing lactose and X-Gal;
(c) the strain deposited with DSMZ under accession number DSM 28953;
(d) a strain derived from DSM 28953, wherein the derived strain is able to generate white colonies on a medium containing lactose and X-Gal;
(e) the strain deposited with DSMZ under accession number DSM 32599;
(f) a strain derived from DSM 32599, wherein the derived strain is able to generate white colonies on a medium containing lactose and X-Gal;
(g) the strain deposited with DSMZ under accession number DSM 32600; and
(h) a strain derived from DSM 32600, wherein the derived strain is able to generate white colonies on a medium containing lactose and X-Gal;
(ii) the lactose-deficient strain comprises one or more lactose-deficient Lactobacillus strains selected from:
(a) the strain deposited with DSMZ under accession number DSM 28910; and
(b) a strain derived from DSM 28910, wherein the derived strain is able to generate white colonies on a medium containing lactose and X-Gal; and
(iii) the probiotic strain comprises one or more selected from Lactobacillus rhamnosus strain LGG® deposited at the ATCC as ATCC 53103, Lactobacillus paracasei strain L. casei 431® deposited at the ATCC as ATCC 55544, Lactobacillus acidophilus strain LA-5® deposited at DSMZ under accession number DSM 13241, and Bifidobacterium animalis subsp. lactis strain BB-12® deposited at the DSMZ under accession number DSM 15954.

34. A composition for producing a fermented milk product, comprising
(i) a lactic acid bacteria starter culture comprising a lactose-deficient lactic acid bacteria strain capable of metabolizing a non-lactose carbohydrate, wherein the lactose-deficient strain comprises one or more selected from lactose-deficient Streptococcus thermophilus strains and lactose-deficient Lactobacillus strains;
(ii) non-lactose carbohydrate(s) capable of being metabolized by the lactose-deficient strain(s), wherein the non-lactose carbohydrate(s) is(are) present in an amount that will be depleted when the fermented milk product reaches a target pH of from 4.9 to 5.5.

35. The composition of claim 34, wherein one or more of:
(i) the lactose-deficient strain comprises one or more lactose-deficient Streptococcus thermophilus strains selected from:
(a) the strain deposited with Deutsche Sammlung von Mikroorganismen and Zellkulturen GmbH, (Braunschweig, Germany) (DSMZ) under accession number DSM 28952;
(b) a strain derived from DSM 28952, wherein the derived strain is able to generate white colonies on a medium containing lactose and X-Gal;
(c) the strain deposited with DSMZ under accession number DSM 28953;
(d) a strain derived from DSM 28953, wherein the derived strain is able to generate white colonies on a medium containing lactose and X-Gal;
(e) the strain deposited with DSMZ under accession number DSM 32599;
(f) a strain derived from DSM 32599, wherein the derived strain is able to generate white colonies on a medium containing lactose and X-Gal;
(g) the strain deposited with DSMZ under accession number DSM 32600; and
(h) a strain derived from DSM 32600, wherein the derived strain is able to generate white colonies on a medium containing lactose and X-Gal; and
(ii) the lactose-deficient strain comprises one or more lactose-deficient Lactobacillus strains selected from:
(a) the strain deposited with DSMZ under accession number DSM 28910; and
(b) a strain derived from DSM 28910, wherein the derived strain is able to generate white colonies on a medium containing lactose and X-Gal.

36. The composition of claim 34, wherein the composition further comprises a probiotic strain selected from probiotic Lactobacillus strains and probiotic Bifidobacterium strains.

37. A method of increasing the number of viable probiotic cells in a fermented milk product, comprising fermenting a milk base with a composition according to claim 34 to obtain the fermented milk product, wherein the fermented milk product has an increased number of viable probiotic cells as compared to a fermented milk product fermented with a composition selected from:
(a) a lactic acid bacteria starter culture comprising a lactic acid bacteria strain that is not lactose-deficient, wherein the strain comprises one or more selected from Streptococcus thermophilus strains that are not lactose-deficient and Lactobacillus delbrueckii subsp. bulgaricus strains that are not lactose-deficient; and
(b) a lactic acid bacteria starter culture comprising a lactic acid bacteria starter culture comprising a lactose-deficient lactic acid bacteria strain capable of metabolizing a non-lactose carbohydrate, wherein the lactose-deficient strain comprises one or more selected from lactose-deficient Streptococcus thermophilus strains and lactose-deficient Lactobacillus strains, and one or more non-lactose carbohydrate(s) capable of being metabolized by the lactose-deficient strain(s), wherein the non-lactose carbohydrate(s) is(are) present in the composition in an amount that will be depleted when the fermented milk product reaches a pH below 4.9.
